(19) United States
(12) Patent Application Publication
(10) Pub. No.: US 2026/0278293 A1
(43) Pub. Date: Sep. 17, 2026

(54) SYSTEM

(71) Applicant: SoftBank Group Corp., Tokyo (JP)

(72) Inventor: Hiroshi OYAMA, Tokyo (JP)

(73) Assignee: SoftBank Group Corp., Tokyo (JP)

(21) Appl. No.: 19/548,957

(22) Filed: Feb. 25, 2026

Related U.S. Application Data
(60) Provisional application No. 63/770,236, filed on Mar. 11, 2025.

(51) Int. Cl. G06F 40/40; G06F 3/01; G06F 40/205; G06F 40/284; G06N 3/0455; G10L 13/02

(52) U.S. Cl. CPC G06F 40/40; G06F 3/013; G06F 40/205; G06F 40/284; G06N 3/0455; G10L 13/02

(57) ABSTRACT

A system includes a processor that is configured to learn user knowledge, language patterns, and past conversation histories by a learning unit, acquire a current situation and context of a user by a context acquisition unit, predict content that the user is likely to want to say next by a prediction unit, present a plurality of predicted conversation candidates to the user by a presentation unit, receive, by a selection unit, a selection made by the user from among the presented conversation candidates, and store, by a feedback unit, a result of the selection as learning data so as to improve prediction accuracy in subsequent predictions.

### CROSS-REFERENCE TO RELATED APPLICATION

This application claims the benefit of U.S. Provisional Application No. 63/770,236, filed on Mar. 11, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional communication support systems for users having language impairments or other communication difficulties often rely on fixed phrase lists or simple rule-based suggestion mechanisms that do not adequately adapt to individual user characteristics. Such systems typically fail to learn user-specific knowledge, language patterns, or detailed past conversation histories, and therefore cannot accurately predict what a particular user is likely to want to say next. As a result, the user is required to perform many operations to find an appropriate phrase, which increases cognitive and physical burden and reduces the speed and smoothness of communication. In addition, many existing systems do not sufficiently take into account real-time contextual information, such as the user's current location, time, or environmental conditions, which leads to presentation of conversation candidates that are not suitable for the actual situation. Furthermore, feedback from the user's selections is often not effectively used to update the underlying prediction model, so that the system cannot continuously improve its prediction accuracy over long-term use. Therefore, there is a need for a system that can: (i) learn user-specific knowledge, language patterns, and past conversation histories; (ii) acquire and utilize current context information of the user; (iii) automatically predict and present suitable conversation candidates; and (iv) incorporate feedback from user selections to improve prediction accuracy in a continuous and adaptive manner, thereby reducing the user's burden and enabling more natural and efficient communication.

### SUMMARY

In order to solve the above-described problems, the present invention provides a system comprising a processor, wherein the processor is configured to learn user knowledge, language patterns, and past conversation histories by a learning unit, acquire a current situation and context of a user by a context acquisition unit, predict content that the user is likely to want to say next by a prediction unit, present a plurality of predicted conversation candidates to the user by a presentation unit, receive, by a selection unit, a selection made by the user from among the presented conversation candidates, and store, by a feedback unit, a result of the selection as learning data so as to improve prediction accuracy in subsequent predictions. In one aspect, the processor is configured to model user utterance patterns in the learning unit by using natural language processing techniques and by utilizing a recurrent neural network and a transformer model to learn the user knowledge, the language patterns, and the past conversation histories, thereby constructing a user-adaptive language model capable of capturing temporal and contextual dependencies in user utterances. In another aspect, the processor is configured to enable the user to intuitively operate the selection unit by using at least one of an eye-tracking device, a touch screen, and a voice command so that a phrase selected by the user from among the presented conversation candidates is directly conveyed to a communication partner. By integrating these units, the system can continuously adapt to each user's communication style, dynamically generate context-appropriate conversation candidates, and reduce the user's operational burden, thereby achieving smoother and more efficient communication support for users with language impairments or similar communication needs.

The term “system” refers to an arrangement of hardware and software components, including at least one processor and associated functional units, that cooperatively perform the operations described in the claims.

The term “processor” refers to one or more hardware computing elements, such as a central processing unit (CPU), a microprocessor, a graphics processing unit (GPU), or a combination thereof, configured to execute instructions to perform the claimed functions.

The term “learning unit” refers to a functional module implemented by the processor and associated memory that is configured to acquire, analyze, and store user knowledge, language patterns, and past conversation histories, and to build or update a user-specific language model based on such data.

The term “context acquisition unit” refers to a functional module implemented by the processor and associated components that is configured to obtain information representing a current situation and context of a user, including, for example, location, time, environmental conditions, and surrounding circumstances.

The term “prediction unit” refers to a functional module implemented by the processor that is configured to generate, based on outputs of the learning unit and the context acquisition unit, a prediction of content that the user is likely to want to say next.

The term “presentation unit” refers to a functional module implemented by the processor and associated output interfaces, such as a display or speaker, that is configured to present a plurality of predicted conversation candidates to the user in a perceivable form. The term “selection unit” refers to a functional module implemented by the processor and associated input interfaces that is configured to receive a selection made by the user from among the conversation candidates presented by the presentation unit.

The term “feedback unit” refers to a functional module implemented by the processor and associated storage that is configured to store a result of the user's selection as learning data and to provide the stored data to the learning unit so as to improve prediction accuracy in subsequent predictions.

The term “user knowledge” refers to information related to the user's personal preferences, commonly used expressions, subject-matter familiarity, and other individual characteristics that influence the user's choice of words or phrases.

The term “language patterns” refers to regularities in the user's use of words, phrases, syntax, and style, including frequency, order, and combinations of expressions observed in the user's past utterances.

The term “past conversation histories” refers to recorded data of previous communications involving the user, including at least the text or content of utterances and, optionally, associated metadata such as timestamps, topics, and contextual information.

The term “current situation and context” refers to information that represents conditions surrounding the user at a given time, including, for example, place, time of day, environmental noise level, nearby people, and ongoing activities, which may influence what the user is likely to want to say.

The term “conversation candidate” refers to a phrase, sentence, or other linguistic expression generated or selected by the system as a possible next utterance that the user may wish to communicate.

The term “natural language processing techniques” refers to computational methods for analyzing, modeling, and generating human language, including, for example, tokenization, embedding, parsing, sequence modeling, and language modeling.

The term “recurrent neural network” refers to a type of neural network architecture that processes sequential data by maintaining a state that is updated over time, enabling the modeling of temporal dependencies between elements in a sequence such as words in an utterance.

The term “transformer model” refers to a type of neural network architecture that relies primarily on self-attention mechanisms to process sequences of data in parallel, enabling the modeling of long-range dependencies in language without relying on recurrent connections. The term “eye-tracking device” refers to a sensor system configured to detect and track the position or movement of the user's eyes or gaze direction, and to convert such information into input signals for selecting conversation candidates.

The term “touch screen” refers to a display device capable of detecting physical contact or proximity from a finger, stylus, or other object, and of generating corresponding input signals that can be used for selecting conversation candidates.

The term “voice command” refers to a spoken instruction issued by the user, recognized by a speech recognition component, and interpreted as an input operation for selecting or controlling conversation candidates.

The term “communication partner” refers to a person or external entity to whom the user wishes to convey a selected phrase or message, including, for example, caregivers, family members, service personnel, or conversational agents.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

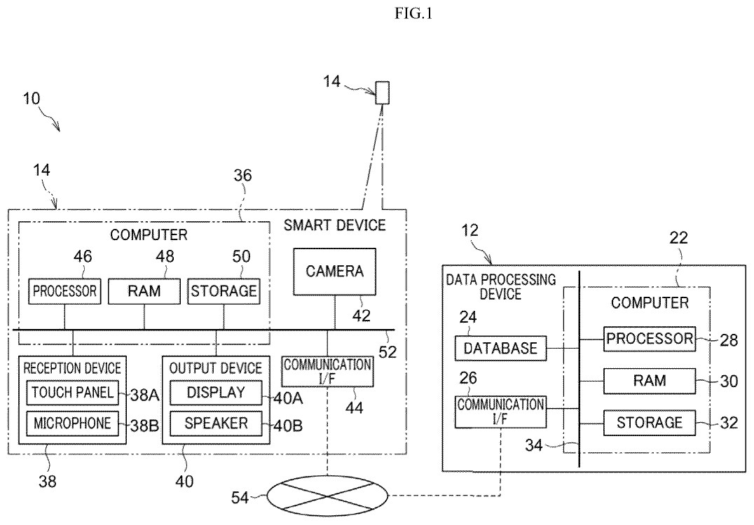

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

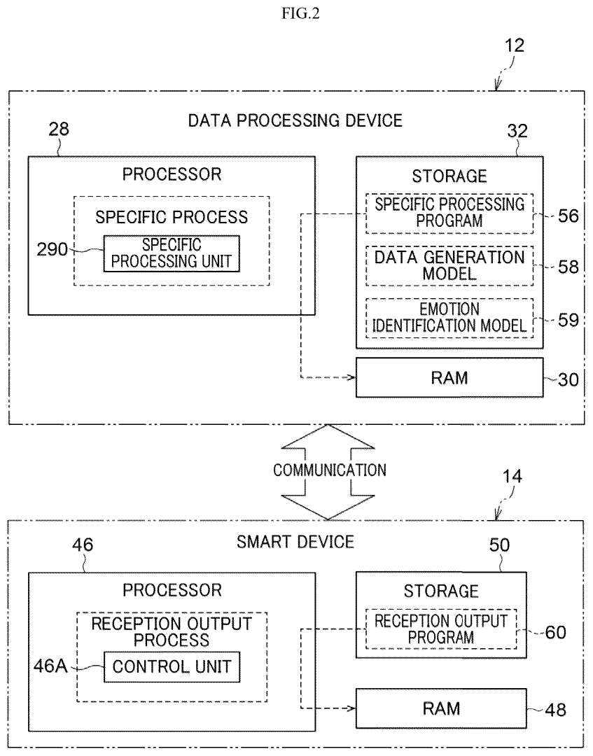

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional communication support systems that present fixed phrase lists or simple predictive text suffer from several technical limitations. First, such systems typically rely on static dictionaries or shallow statistical models executed on general-purpose hardware, which do not effectively adapt to long-term, user-specific language patterns and context. As a result, the ranking and selection of candidate utterances often produce low-relevance suggestions, causing increased interaction latency, higher error rates in user selection, and inefficient utilization of processing resources.

Second, known systems generally process context information (such as location, time, and environmental noise) in isolation from user conversation history. This separation leads to a fragmented data flow in which context signals are not coherently integrated with past dialogue data at the model-input level. Consequently, the underlying computation fails to exploit temporal and contextual correlations, resulting in suboptimal candidate generation and poor personalization, particularly in real-time or resource-constrained environments. Third, existing implementations that incorporate machine learning frequently treat the generative model as a black box without a structured prompt layer. They do not programmatically construct and update machine-readable instruction sentences (“prompts”) that encode user history, context, and preferences as meta-information. This absence of a systematic prompt construction mechanism limits the ability of the processing circuitry to efficiently steer a generative AI model and to reuse a common model across heterogeneous users and dynamic contexts, thereby increasing computational overhead and reducing scalability.

Fourth, feedback from user selections is often logged in an ad hoc manner without being tightly coupled to the context under which the selection occurred. This leads to inefficient learning loops, where the system cannot precisely associate selection events with specific environmental conditions or prior model states. As a result, model updates are coarse-grained, require large batched retraining, and cannot promptly improve prediction quality in an online fashion. This degrades responsiveness, wastes compute cycles, and prevents the system from converging quickly to a highly personalized behavior.

Fifth, some existing systems perform only rudimentary security handling and do not tightly integrate encryption and secure transport into the data processing pipeline for user conversation history, context signals, and feedback logs. This can constrain deployment in regulated environments, force additional middleware layers, and complicate the overall architecture, leading to inefficiencies and increasing the engineering burden of ensuring end-to-end confidentiality within the core communication support workflow.

Accordingly, there is a need for a technical solution that improves the operation of computer systems implementing communication assistance by (i) unifying user history, context acquisition, prompt construction, generative candidate generation, ranking, and feedback-driven adaptation into a single integrated processing pipeline, (ii) enabling a processor to construct prompt sentences with embedded meta-information to control a generative AI model more effectively, (iii) using fine-grained feedback linked to context for incremental model and ranking updates, and (iv) performing these operations while maintaining encrypted storage and secure communication, thereby improving prediction accuracy, reducing user interaction latency, and enhancing computational efficiency and scalability.

The specific processing by the specific processing unit 290 of the data processing device 12 in Example 1 is realized by the following means.

The present invention provides a server comprising a processor configured to store and preprocess user knowledge information, language pattern information, and conversation history information, to acquire situation information including location information, time information, and environmental sound information from a terminal device and structure the situation information as context information, to generate a generation instruction sentence as a prompt sentence including meta-information comprising at least the conversation history information of a user, the context information, and user preference information, and including an instruction phrase requesting generation of multiple conversation candidate information items optimized for a current context, to input the prompt sentence into a generative AI model implemented as a neural network that has been pretrained for natural language processing and fine-tuned based on the conversation history information of the user, to cause the generative AI model to probabilistically generate a plurality of conversation candidate information items that the user is likely to speak next, to rank the plurality of conversation candidate information items and select presentation candidate information items based on safety rules and the user preference information, to transmit the presentation candidate information items to the terminal device for presentation as card-type or similar visual elements, to acquire a selection result made by the user from among the presentation candidate information items by using at least one of a gaze detection mechanism, a contact detection mechanism, and a voice recognition mechanism, to output conversation candidate information corresponding to the selection result to a communication partner via at least one of a voice output mechanism and a display output mechanism, to store the selection result in association with the context information at a time of selection as evaluation information and update at least one of the generative AI model and a candidate ranking process based on the evaluation information so as to improve generation accuracy of conversation candidate information in subsequent processing, to automatically increase an output priority of conversation candidate information that is frequently selected under similar context information based on the evaluation information, and to encrypt and store at least the conversation history information, the context information, and the evaluation information of the user and perform communication with the terminal device using an encrypted communication scheme. This enables an integrated and technically improved data processing pipeline in which a single processor coordinates contextual data acquisition, structured prompt construction, generative candidate creation, adaptive ranking, and secure feedback-driven model updating, thereby enhancing prediction accuracy, reducing user interaction latency, improving resource efficiency of the generative AI model, and providing a scalable and privacy-preserving communication assistance platform.

The term “user knowledge information” refers to information representing a user's domain knowledge, interests, and preferences, including but not limited to frequently discussed topics, subject-matter familiarity, and typical content the user chooses to communicate.

The term “language pattern information” refers to information representing statistical and structural characteristics of a user's language usage, including word and phrase frequencies, typical sentence structures, recurrent expressions, and temporal patterns of utterances. The term “conversation history information” refers to information representing past communication data associated with a user, including text or symbol sequences of utterances, timestamps, interaction contexts, and records of selected candidate utterances.

The term “situation information” refers to information obtained from one or more devices that characterizes a user's current environment, including location information, time information, and environmental sound information, and optionally additional sensor data.

The term “location information” refers to information indicating a geographical position or place of a user or a device, including, for example, coordinates, region identifiers, or derived place categories.

The term “time information” refers to information indicating temporal aspects of a user's situation, including absolute time, date, and derived categories such as time-of-day segments or periodic patterns.

The term “environmental sound information” refers to information obtained from an audio sensing mechanism indicating characteristics of ambient sound, including sound level, noise profile, or classification of environmental sound types.

The term “context information” refers to structured information derived from situation information and optionally other data sources, representing a user's current environment and circumstances in a form usable by a processing circuit for prediction and generation. The term “user preference information” refers to information representing patterns of a user's selections and choices over time, including preferred topics, frequently selected phrases, and situational preferences inferred from feedback data.

The term “generation instruction sentence” refers to a machine-readable instruction string that specifies how a language model is to generate one or more outputs, including constraints on style, quantity, or form of the outputs.

The term “prompt sentence” refers to a generation instruction sentence that includes both an instruction portion and meta-information regarding user history, context, and preferences, and that is supplied as input to a generative AI model.

The term “generative AI model” refers to a machine learning model configured to generate new data, such as natural language text, in response to an input, and implemented, for example, as a pretrained and optionally fine-tuned neural network for language generation. The term “language generation model” refers to a model, typically implemented as a neural network, that predicts or generates sequences of linguistic units, such as words or tokens, based on prior input and learned parameters.

The term “neural network” refers to a computational model comprising interconnected processing units organized in layers, configured to learn mappings from input data to output data through training with optimization of model parameters.

The term “pretrained natural language processing model” refers to a language-related neural network that has been trained in advance on a large corpus of text to learn general linguistic patterns prior to being adapted to a specific user or task.

The term “fine-tuned” refers to a process of further training a pretrained model on additional, typically smaller and more specific, data such as a user's conversation history, to adapt the model parameters to the specific characteristics of that data.

The term “conversation candidate information” refers to information representing one possible utterance or phrase that a user might want to output in a given context, including the textual content and optionally associated scores or metadata.

The term “presentation candidate information” refers to one or more conversation candidate information items selected and prepared for output to a user, for example after ranking, filtering, and safety checking.

The term “safety rules” refers to predefined conditions and constraints used to evaluate and filter generated content, including rules to detect and prevent output of inappropriate, harmful, or disallowed expressions.

The term “ranking” refers to a process of ordering multiple candidate items according to one or more criteria, such as probability, relevance, user preference scores, or safety evaluations. The term “terminal device” refers to an end-user device configured to interact with the server, including, for example, a smartphone, tablet, dedicated communication aid, or other computing device with input and output capabilities.

The term “visual display unit” refers to a component or subsystem of a device that provides visual output, such as a screen, monitor, or display panel capable of presenting graphical elements to a user.

The term “card-type or similar visual elements” refers to graphical user interface components that visually separate and highlight individual items, such as rectangular panels, tiles, buttons, or other discrete visual units representing candidate utterances.

The term “gaze detection mechanism” refers to hardware and/or software configured to detect a user's eye position or gaze direction relative to a display, and to infer a selection or focus based on gaze behavior.

The term “contact detection mechanism” refers to hardware and/or software configured to detect physical interaction with a device, such as touch input on a touch-sensitive surface or activation of a physical control.

The term “voice recognition mechanism” refers to hardware and/or software configured to process audio input and recognize spoken commands or words, and to map recognized speech to control or selection actions.

The term “voice output mechanism” refers to a component or subsystem configured to produce audible output, including, for example, a text-to-speech engine and one or more speakers.

The term “display output mechanism” refers to a component or subsystem configured to visually present information, including text or graphics, on a display device for viewing by a user or another person.

The term “selection result” refers to information indicating which one or more candidate items have been chosen by a user from among presented candidates, including identifiers or representations of the chosen items.

The term “evaluation information” refers to information that associates a selection result with corresponding context information and other metadata, and that is used to evaluate and improve future predictions and generation.

The term “candidate ranking process” refers to computational operations that assign scores or order to a set of generated candidate items and produce a ranked list for subsequent selection or filtering.

The term “output priority” refers to a relative measure or weight that influences the likelihood or position of a candidate item being presented or output before other candidate items. The term “encrypted communication scheme” refers to a communication protocol or method that applies cryptographic techniques to protect data exchanged between devices from unauthorized access or tampering.

The term “encrypt and store” refers to performing a cryptographic transformation on data prior to storing it in a memory or storage medium, such that the data is not directly readable without appropriate decryption credentials.

In one embodiment, a server cooperates with a terminal to provide personalized communication assistance based on a generative AI model controlled by structured prompt sentences. The server is implemented on a computing platform that includes one or more processors, such as general-purpose central processing units and acceleration units such as graphics processing units. The server uses persistent storage devices, such as magnetic disks, solid-state drives, or network-attached storage, to store user knowledge information, language pattern information, conversation history information, context information, and evaluation information. The server executes a program written in a general-purpose programming language such as a high-level language and uses software libraries for natural language processing and neural network processing, such as a neural network framework and a language processing library.

The terminal is implemented as a user-operated computing device, such as a smartphone, tablet, or dedicated communication aid device, and includes a processor, a memory, a touch-sensitive display, a microphone, a speaker, and optional sensors such as a camera and an eye-tracking unit. The terminal executes an application that communicates with the server over an encrypted network channel using a secure protocol such as a transport layer security-based protocol. The terminal acquires situation information including location information via an operating system location service, time information via a system clock, and environmental sound information via an audio capture application programming interface. The terminal sends this situation information to the server in a structured data format over the secure network channel.

The server stores user knowledge information, language pattern information, and conversation history information in a database. The server represents conversation history information as a sequence of records, each record including fields such as a user identifier, a timestamp, a text string of an utterance, a context identifier, and a candidate identifier when the utterance originates from a candidate selection. The server stores context information in a separate data structure, for example a context table, in which each context entry includes fields for location category, time-of-day category, noise level, and other derived parameters. The server stores evaluation information in an evaluation table that associates a selected candidate identifier with the corresponding context identifier and with a selection outcome label, such as “selected”, “skipped”, or “rejected”.

The server preprocesses the conversation history information using a natural language processing pipeline. The server uses tokenization algorithms provided by a language processing library to segment texts into tokens, normalizes case, and optionally removes or annotates punctuation. The server converts tokens into numerical identifiers using a vocabulary associated with a language generation model. The server constructs sequences of token identifiers corresponding to prior utterances, and stores these sequences as compressed numeric arrays or as serialized tensor structures in storage. The server computes statistical language pattern information, including token frequency counts, n-gram frequency counts, and sentence length distributions, using vectorized numerical operations. The server updates language pattern information whenever new conversation history information is stored. The server implements the generative AI model as a neural network based on a transformer architecture for language generation. The server loads a pretrained natural language processing model that has been trained on a large corpus of text data to learn general linguistic patterns. The server fine-tunes this model using conversation history information of a particular user. During fine-tuning, the server feeds sequences of token identifiers into the neural network and computes a loss function such as cross-entropy between predicted token distributions and actual next tokens. The server computes gradients of the loss with respect to neural network parameters using backpropagation, and updates the parameters using an optimization algorithm such as stochastic gradient descent or an adaptive optimizer. The server repeats this process over many mini-batches of user-specific conversation data, thereby adapting the model parameters to the user's speech patterns.

The server configures the transformer network with multiple layers of self-attention and feed-forward sublayers, with parameters such as the number of layers, the dimensionality of the hidden representations, and the number of attention heads selected to balance generation quality and computational efficiency. The server uses positional encodings to represent token order within sequences. By adapting only a subset of model parameters, such as the top layers or additional adapter modules, the server reduces computation time relative to full retraining, which constitutes an improvement in computing efficiency.

The server constructs context information by interpreting raw situation information received from the terminal. The server maps raw location coordinates to a location category, such as “home”, “workplace”, or “café”, using a geospatial lookup procedure or a location classification algorithm. The server determines a time-of-day category, such as “morning” or “evening”, by comparing the time information to predefined intervals. The server analyzes environmental sound information by computing an average power level or a spectrum-based indicator and mapping it to a noise level category such as “low”, “medium”, or “high”. The server stores these derived context parameters in a compact representation, such as enumerated codes, to enable efficient indexing and retrieval.

The server generates a prompt sentence by combining a textual instruction with meta-information describing the user and context. The server retrieves a subset of recent conversation history information, such as the last several utterances, and retrieves associated context information from the context table. The server also retrieves user preference information from the evaluation table in the form of frequency counts of selected phrases conditioned on context categories. The server then programmatically assembles a prompt sentence that includes these elements in natural language form. For example, the server may generate a prompt sentence such as:

“You are a personalized communication assistant for a user with a speech impairment. The user is now at a café in the morning, with medium background noise. The user often orders coffee at this place. Based on the following past utterances: [‘Good morning’, ‘Table for one, please’], generate five short candidate sentences that the user might want to say next. Use polite, concise sentences, no more than 15 words each.”

In another example, the server may generate a prompt sentence such as:

“Based on this user's past conversation history and the current context (café, morning, medium noise), generate five short polite candidate sentences that the user might want to say next.”

In yet another example, the server may generate a prompt sentence such as:

“Using the following feedback log, update your internal preference model so that phrases frequently selected in similar contexts receive higher scores in future predictions.” By encoding user-specific and context-specific meta-information into a structured prompt sentence, the server uses the generative AI model in a non-generic way that improves the model's output relevance and reduces the need for downstream filtering.

The server inputs the prompt sentence into the generative AI model and sets decoding parameters such as temperature, top-k, and top-p to control the diversity of the generated outputs. The server obtains text output from the generative AI model and parses it into multiple candidate utterances. The server optionally computes internal confidence scores using the model's token probabilities. The server applies safety rules implemented as a set of pattern-matching filters or as an auxiliary classification model to detect and remove inappropriate or irrelevant candidates. The server ranks the remaining candidates based on a linear or non-linear scoring function that combines model confidence, similarity to user-preferred patterns, and context relevance.

The server stores each candidate with an associated candidate identifier, the full text, a score, and a context reference. The server transmits a subset of the highest-ranked candidates to the terminal as presentation candidate information. The server encodes the candidate list in a compact message format to reduce communication load, for example by sending only candidate identifiers and compressed text strings.

The terminal receives the presentation candidate information and renders user interface elements on the touch-sensitive display. The terminal uses a graphical user interface framework to draw card-type or similar visual elements, each card containing a candidate utterance string. The terminal arranges the cards in a layout that emphasizes the highest-ranked candidates, for example by placing them in prominent positions or using larger font sizes. The terminal may also adjust visual properties based on accessibility settings, such as increasing contrast or enlarging text for users with visual impairments.

The terminal detects user input through multiple mechanisms. When an eye-tracking unit is present, the terminal uses a gaze detection mechanism to determine which card the user is looking at by mapping gaze coordinates to screen regions. When a dwell time on a particular card exceeds a threshold, the terminal interprets this as a selection result. When the user touches the display, the terminal's contact detection mechanism identifies the card under the touch event and registers the corresponding selection. When the user issues a spoken command, the terminal uses a voice recognition mechanism to recognize utterances such as “select the first option” and maps the recognized phrase to a card index.

After a selection result is determined, the terminal verifies the selection with a confirmation indication on the display or via a short audio tone. The terminal then outputs the selected candidate utterance to a communication partner. The terminal displays the selected text in a prominent area on the screen and uses a text-to-speech engine to synthesize audio output through the speaker. This audio output is generated in real time, enabling the user to participate in spoken interactions.

The server receives the selection result from the terminal as evaluation information. The server stores the evaluation information in association with the context information that was active at the time of selection. The server updates user preference information by incrementing counters for the selected candidate or for phrases contained within the candidate, conditioned on the associated context categories. The server uses these counts to compute preference scores, which are then used to adjust candidate ranking in subsequent sessions. In some embodiments, the server uses the evaluation information to further fine-tune the generative AI model with online or periodic batch training on newly collected data, thereby refining the model weights.

The server improves computational efficiency and prediction accuracy through specific data structures and control logic. By structuring context information as categorical codes and maintaining indexed tables for conversation history and evaluation information, the server reduces retrieval time when constructing prompt sentences and computing preference scores. By leveraging a single generative AI model with dynamic, user-specific prompt sentences, the server avoids maintaining separate full-scale models for each user, thus reducing memory usage and training cost. The prompt construction process serves as a technical mechanism to condition the generative AI model without replicating its parameters, which constitutes an improvement in resource efficiency at the system level.

The server reduces communication burden between the server and the terminal by transmitting only compact representations of candidates and context identifiers rather than full historical data. The server also reduces latency by performing ranking and filtering centrally, allowing the terminal to focus on rendering and input sensing. This division of labor between the server and the terminal leads to lower overall energy consumption on the terminal and more predictable processing on the server.

The system improves computer technology in several respects beyond mere automation of human tasks. First, the integration of user-specific fine-tuning and context-aware prompt construction into a single processing pipeline yields more accurate predictions per computational step, reducing redundant candidate generation and filtering. Second, the use of structured meta-information in the prompt sentences introduces a non-conventional control layer over the generative AI model, enabling dynamic reconfiguration of model behavior without reloading or reinitializing the model. Third, the association of evaluation information with fine-grained context categories allows the server to implement non-standard, context-conditioned ranking adaptations that improve convergence speed and reduce error rates in candidate presentation.

In another embodiment, the server implements different neural network architectures, such as a recurrent neural network or a hybrid architecture combining recurrent and transformer layers. The server may employ different loss functions, such as label-smoothed cross-entropy, and different optimization algorithms, such as momentum-based gradient descent. The server may also perform data augmentation on the conversation history information, such as paraphrasing training utterances or adding noise to token sequences, to improve model robustness. These alternative configurations maintain the same overall data flow and technical effects but allow adaptation to specific deployment constraints.

In yet another embodiment, the terminal may implement a portion of the language generation model locally, for example a smaller ranking or scoring model, while the server retains the main generative AI model. The terminal may compute context-specific embeddings of candidate utterances and locally re-rank candidates based on recent micro-interactions, thereby further reducing round-trip latency. The server can provide updated model parameters to the terminal periodically, allowing the system to operate in environments with intermittent connectivity while still benefiting from central model improvements.

Across these embodiments, the server, the terminal, and the user interact through concrete hardware and software elements, specific data structures, and well-defined processing flows that enable the generative AI model to be controlled via prompt sentences enriched with meta-information. This configuration yields tangible technical improvements in prediction accuracy, processing speed, communication efficiency, and data management, and provides a robust and scalable platform for communication assistance in real-world environments.

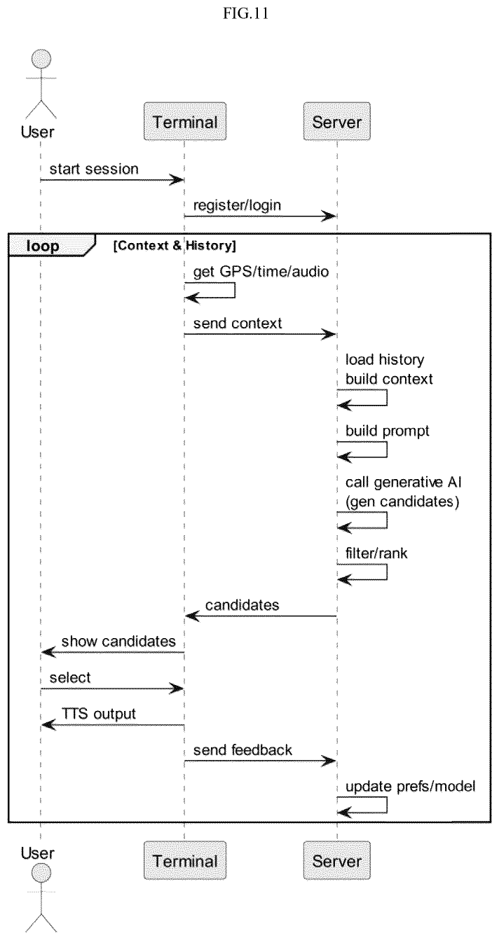

The following describes the processing flow using FIG. 11.

### Step 1:

The server initializes user records.

The server receives, as input, a user registration request including a user identifier and basic profile settings from the terminal.

The server stores, as output, an initialized user profile entry, an empty conversation history list, an empty context history list, and an empty evaluation history list in a database.

The server allocates database tables or collections and associates primary keys with the user identifier to enable subsequent fast lookup of conversation history, context information, and evaluation information.

### Step 2:

The terminal initializes a communication session.

The terminal receives, as input, user login data and a session start instruction from the user. The terminal generates, as output, a session identifier and a device token, and sends these values to the server via an encrypted communication channel.

The terminal stores the session identifier locally and activates application modules for context acquisition, display rendering, and user input capture.

### Step 3:

The server loads and preprocesses conversation history information.

The server receives, as input, the user identifier and session identifier from the terminal.

The server retrieves, as data input, past conversation records for the user from a conversation history table, including text strings and timestamps.

The server performs, as data processing, tokenization of each text string, mapping of tokens to token identifiers using a vocabulary, and computation of statistical features such as token frequency vectors and n-gram counts.

The server stores, as output, preprocessed token sequences and language pattern information in an in-memory data structure and, when necessary, updates corresponding database entries.

### Step 4:

The server adapts a language generation model to the user.

The server receives, as input, the preprocessed token sequences and language pattern information from Step 3.

The server feeds token sequences into a transformer-based neural network model and computes, as data processing, a loss value such as cross-entropy between predicted token distributions and actual tokens.

The server applies backpropagation and an optimization algorithm to update selected model parameters, such as weights in upper layers or adapter modules, thereby fine-tuning the generative AI model.

The server stores, as output, an updated set of model parameters associated with the user identifier and marks the corresponding model version as active for the session.

### Step 5:

The terminal acquires situation information.

The terminal receives, as input, a context acquisition trigger when the session becomes active or when the user opens a communication screen.

The terminal reads, as data input, location coordinates from an operating system location service, current time from a system clock, and raw audio samples from a microphone through an audio API.

The terminal computes, as data processing, a noise level indicator from the audio samples by calculating average power or spectrum features.

The terminal constructs, as output, a situation information packet including location coordinates, time stamp, and noise level indicator, and transmits the packet to the server over the secure channel.

### Step 6:

The server converts situation information into structured context information.

The server receives, as input, the situation information packet from the terminal.

The server maps, as data processing, the location coordinates to a location category using a geospatial lookup or rules, maps the time stamp to a time-of-day category, and maps the noise level indicator to a discrete noise category.

The server generates, as output, a context information record containing codes for location category, time-of-day category, and noise category, and stores this record in a context table associated with the session identifier.

### Step 7:

The server retrieves recent interaction and preference information.

The server receives, as input, the user identifier and the context information record from Step 6.

The server queries, as data input, the conversation history table for the latest several utterances and the evaluation history table for selection frequencies of candidate phrases under similar context categories.

The server aggregates, as data processing, the retrieved records into a compact structure that includes a list of recent utterances and preference scores for frequently selected phrases.

The server outputs this aggregated structure to a prompt construction module.

### Step 8:

The server constructs a prompt sentence.

The server receives, as input, the context information record and the aggregated conversation and preference information from Step 7.

The server concatenates, as data processing, textual descriptions of the context (such as “café”, “morning”, “medium noise”) with examples of recent user utterances and guidance derived from preference scores into a natural language instruction.

The server formats, as output, a prompt sentence, for example:

“You are a personalized communication assistant for a user with a speech impairment. The user is now at a café in the morning, with medium background noise. The user often orders coffee at this place. Based on the following past utterances: [‘Good morning’, ‘Table for one, please’], generate five short candidate sentences that the user might want to say next. Use polite, concise sentences, no more than 15 words each.” The server passes this prompt sentence to the generative AI model interface.

### Step 9:

The server generates conversation candidate information using the generative AI model.

The server receives, as input, the prompt sentence produced in Step 8.

The server encodes, as data processing, the prompt sentence into token identifiers using the model's tokenizer and feeds these identifiers into the fine-tuned transformer network. The server performs probabilistic decoding using configured parameters such as temperature, top-k, or top-p to sample or search for multiple candidate sequences of tokens.

The server converts, as output, the generated token sequences into text strings and associates each string with a candidate identifier and an internal probability score.

### Step 10:

The server filters and ranks the candidate utterances.

The server receives, as input, the generated candidate text strings and associated scores from

### Step 9.

The server applies, as data processing, safety rules implemented as pattern checks or classifier scores to remove candidates containing disallowed or irrelevant content.

The server combines model scores with user preference scores and context compatibility scores to compute a final ranking score for each remaining candidate.

The server outputs a ranked list of presentation candidate information items, each including a candidate identifier, text, and ranking score.

### Step 11:

The server transmits presentation candidate information to the terminal.

The server receives, as input, the ranked list from Step 10.

The server selects, as data processing, a subset of top-ranked candidates according to a maximum display capacity or score threshold.

The server packages, as output, the selected candidate identifiers and text strings into a compact message and sends the message to the terminal over the encrypted channel.

### Step 12:

The terminal presents candidate utterances to the user.

The terminal receives, as input, the message containing presentation candidate information from the server.

The terminal parses, as data processing, the message into individual candidate records and maps them to visual elements in a graphical user interface layout.

The terminal renders, as output, card-type or similar visual elements on the display, each card showing one candidate utterance, with more important candidates placed in prominent positions or shown with larger fonts.

### Step 13:

The terminal captures user selection via available input modalities.

The terminal receives, as input, gaze coordinates from an eye-tracking unit, touch events from the touch-sensitive display, and voice signals from the microphone.

The terminal maps, as data processing, gaze coordinates and touch positions to on-screen card regions, and sends voice signals to a voice recognition module that outputs recognized text commands such as “select option one”.

The terminal decides, as output, which candidate card is selected when a dwell time threshold is exceeded for gaze, when a specific card is tapped, or when a recognized command refers to a card index.

### Step 14:

The terminal outputs the selected utterance to a communication partner.

The terminal receives, as input, the identifier and text of the selected candidate from Step 13.

The terminal forwards, as data processing, the selected text to a text-to-speech engine, which synthesizes an audio waveform for the utterance.

The terminal outputs, as output, the spoken utterance through the speaker and simultaneously displays the text prominently on the screen for visual confirmation.

### Step 15:

The terminal sends feedback information to the server.

The terminal receives, as input, the selection event consisting of the selected candidate identifier, the time of selection, and the current context identifier.

The terminal constructs, as data processing, a feedback message including the user identifier, session identifier, selected candidate identifier, and context information reference.

The terminal transmits, as output, the feedback message to the server over the encrypted communication channel.

### Step 16:

The server updates evaluation information and preference scores.

The server receives, as input, the feedback message from the terminal.

The server records, as data processing, a new evaluation entry that links the selected candidate identifier with the associated context information and labels this entry as a successful selection.

The server updates, as output, selection frequency counts and derived preference scores for the selected candidate and for its constituent phrases under the corresponding context categories in the evaluation table.

### Step 17:

The server adjusts ranking logic based on updated preferences.

The server receives, as input, updated preference scores from Step 16.

The server recalculates, as data processing, weighting coefficients used in the ranking function that combines model probability, preference score, and context relevance.

The server updates, as output, ranking parameters in an in-memory configuration used in subsequent candidate ranking, thereby increasing the output priority of candidates frequently selected in similar contexts.

### Step 18:

The server optionally performs incremental fine-tuning of the generative AI model.

The server receives, as input, newly logged conversation samples and feedback-labeled data from Steps 14 and 16.

The server forms, as data processing, mini-batches consisting of tokenized versions of selected candidates and their contexts, and performs additional training iterations to adjust model weights using the same loss function and optimization algorithm as in Step 4.

The server outputs, as output, an updated model parameter set that more accurately predicts user-preferred utterances under similar context conditions, and stores a new model version linked to the user identifier.

### Step 19:

The server and terminal maintain encrypted storage and communication.

The server receives, as input, raw data such as conversation history, context information, and evaluation information prior to permanent storage.

The server applies, as data processing, encryption operations using cryptographic algorithms to transform the raw data into encrypted data objects before writing to persistent storage. The server and terminal both negotiate, as output, secure session keys for each communication session and continue exchanging all control and content messages over an encrypted communication scheme, thereby preserving confidentiality and integrity of the processed information.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented care support and communication assistance systems primarily rely on static rule sets, simple threshold alerts, or pre-defined dialogue trees. In such systems, a processor typically monitors biological data or user inputs, compares the data against fixed conditions, and triggers a limited set of pre-programmed actions. As a result, these systems exhibit several technical limitations.

First, the systems do not maintain a rich, unified representation of user state that fuses heterogeneous inputs such as biological information, behavior information, care history information, conversation history information, position information, environmental sound information, and activity amount information. Instead, these data streams are processed independently or only loosely correlated, which prevents the processor from leveraging complex temporal and contextual patterns. This leads to inaccurate or delayed detection of appropriate care actions or conversation suggestions, and increases computational inefficiency because multiple ad hoc modules redundantly process overlapping data.

Second, existing systems that incorporate machine learning models typically use them in a closed, static manner. The models are trained offline, deployed with fixed interfaces, and do not dynamically adapt to changing user conditions or care outcomes. There is no integrated mechanism in which the processor continuously associates selection results and subsequent outcomes with prior predictions, and then systematically feeds this association back into the prediction pipeline. This lack of a tightly coupled feedback loop degrades the long-term performance of the models, requires frequent manual reconfiguration, and limits scalability across diverse users.

Third, even when generative AI models are used, they are often invoked in an unstructured way: free-form prompts and free-form outputs are exchanged between the application and the generative AI engine. The processor typically passes loosely defined text prompts and receives unstructured responses, requiring costly post-processing and error-prone parsing. In many cases, this yields inconsistent candidate proposals, unpredictable formatting, and difficulty in ranking or filtering options based on machine-interpretable criteria such as urgency, safety, or expected effect.

Fourth, user interfaces in conventional systems are not tightly integrated into the underlying computational pipeline. The processor may send suggestions to a terminal, but no unified, machine-tractable path exists from presentation, through selection by the user or supporter, to automatic learning of which suggestions were effective. Consequently, the computational components cannot efficiently exploit interaction data to optimize future behavior, resulting in persistent mismatch between the models' behavior and actual user needs.

Accordingly, there is a need for a computer-implemented system and processing architecture in which a processor (i) constructs and maintains unified state feature information and care effect feature information from multimodal, time-series data, (ii) generates structured, machine-interpretable care and conversation candidates by controlling a generative AI model via dynamically constructed prompt sentences, (iii) assigns and uses explicit evaluation indices to rank the candidates, and (iv) embeds a closed feedback loop that associates selection results and subsequent biological and behavioral outcomes with prior predictions, in order to continuously update models and prompt contents. Such a system would improve the technical functioning of the computer by enabling more accurate, consistent, and efficient generation and refinement of care and communication options, reducing manual configuration, and improving the robustness and adaptability of the overall processing pipeline.

The specific processing by the specific processing unit 290 of the data processing device 12 in Application Example 1 is realized by the following means.

The present invention provides a server comprising a processor configured to acquire biological information, behavior information, care history information, and conversation history information of a subject from one or more input devices or external data sources, store the acquired information in a time-series storage, and generate state feature information and care effect feature information for the subject based on the stored information; to acquire position information, environmental sound information, activity amount information, and terminal operation information related to the subject from one or more sensing devices or terminals, and to generate, based on the acquired information, current situation information and context information; to construct, based on at least the state feature information and the context information, a prompt sentence that forms an input text to a generative AI model for generating one or more candidates of care actions or conversation contents to be next provided to the subject, and to input the prompt sentence together with at least part of the state feature information and the context information into an internal or external generative AI model so as to cause the generative AI model to generate a plurality of care candidates or conversation candidates; to analyze, as structured data, the plurality of care candidates or conversation candidates output from the generative AI model, to assign, to each of the plurality of candidates, one or more evaluation indices relating to at least one of urgency, ease of execution, safety, and expected effect, and to rank the plurality of candidates based on the assigned evaluation indices; to transmit the plurality of care candidates or conversation candidates, together with at least part of the evaluation indices, to an information processing terminal having a display device or an audio output device, and to control the information processing terminal to present the plurality of care candidates or conversation candidates visually or audibly in a card format or a list format; to obtain, as a selection result, information indicating at least one candidate selected by at least one of the subject and a supporter through an input device or a voice input device associated with the information processing terminal; and to associate the selection result with at least one of subsequently acquired biological information, behavior information, care result information, and conversation result information, to store the associated information as learning data, and to update at least one of a prediction model used by the processor and contents of the prompt sentence based on the learning data so as to continuously improve accuracy of generation and ranking of the care candidates or conversation candidates in subsequent processing. This enables the computer system to implement an integrated, closed feedback loop in which multimodal time-series data and interaction outcomes are repeatedly fed into a unified processing pipeline that controls the generative AI model through structured prompt sentences, thereby improving the technical performance of the system in terms of accuracy, consistency, and efficiency of candidate generation, ranking, and adaptation over time.

The term “biological information” refers to data representing physiological states of a subject, including but not limited to heart rate, body temperature, blood pressure, blood oxygen saturation, respiration rate, and other measurable vital signs obtained from one or more sensors or measuring devices.

The term “behavior information” refers to data representing actions or activities of a subject, including but not limited to movement patterns, exercise records, daily activity logs, sleep patterns, and other time-series records of physical or behavioral states.

The term “care history information” refers to data representing care actions previously provided to a subject, including but not limited to types of care, timing of care, duration of care, administered substances, applied procedures, and recorded effects or outcomes of such care.

The term “conversation history information” refers to data representing past communication content associated with a subject, including but not limited to textual utterances, transcribed speech, selected phrases, dialogue turns, and associated metadata such as timestamps and interlocutor identifiers.

The term “state feature information” refers to derived data representing a subject's condition, obtained by processing and transforming one or more of biological information, behavior information, care history information, and conversation history information into numerical, categorical, or symbolic features suitable for computational modeling.

The term “care effect feature information” refers to derived data representing relationships between care actions and subsequent outcomes, obtained by processing care history information together with follow-up biological information and behavior information to quantify or characterize the effectiveness of past care.

The term “position information” refers to data representing a spatial location of a subject, including but not limited to indoor location identifiers, coordinates, room identifiers, and zone classifications obtained from positioning systems or location sensors.

The term “environmental sound information” refers to data representing an acoustic state around a subject, including but not limited to sound level, noise classification, and detected sound types obtained from one or more microphones or audio sensors.

The term “activity amount information” refers to data representing a magnitude or level of physical activity of a subject, including but not limited to step counts, acceleration metrics, posture changes, and derived activity level categories obtained from motion sensors or wearable devices.

The term “terminal operation information” refers to data representing interactions with an information processing terminal, including but not limited to input events, selection actions, navigation operations, and timing information associated with use of a user interface. The term “current situation information” refers to data representing a present state of a subject, generated by integrating at least position information, environmental sound information, activity amount information, and terminal operation information at a given time.

The term “context information” refers to data representing an environmental and situational background of a subject, including temporal, spatial, behavioral, and environmental factors that are associated with, and provide interpretation for, the subject's state and interactions. The term “prompt sentence” refers to a text sequence constructed by a processor to be input to a generative AI model, the text sequence including instructions, constraints, and embedded state and context information that guide the generative AI model in generating care candidates or conversation candidates.

The term “generative AI model” refers to a machine-learned model configured to generate new data, including textual output, in response to an input such as a prompt sentence, and implemented by at least one of a neural network, a language model, or another probabilistic generative architecture.

The term “care candidate” refers to a proposed care action generated by the generative AI model, including but not limited to a description of a care procedure, an associated urgency, and a rationale, which is suitable for presentation to a user or supporter and potential execution.

The term “conversation candidate” refers to a proposed communication content element generated by the generative AI model, including but not limited to a phrase, sentence, or utterance together with metadata such as urgency and rationale, which is suitable for presentation and potential use in dialogue.

The term “evaluation index” refers to a numerical or categorical indicator assigned to a care candidate or a conversation candidate, representing at least one aspect of the candidate, such as urgency, ease of execution, safety, or expected effect, for use in ranking or filtering.

The term “urgency” refers to an evaluation index indicating how promptly a care candidate or a conversation candidate should be executed or used, based on the subject's condition and context.

The term “ease of execution” refers to an evaluation index indicating a relative difficulty level of implementing a care candidate or a conversation candidate, considering required resources, time, and operational complexity.

The term “safety” refers to an evaluation index indicating a risk level associated with a care candidate or a conversation candidate, including likelihood and severity of adverse effects on the subject.

The term “expected effect” refers to an evaluation index indicating a predicted positive outcome or benefit associated with a care candidate or a conversation candidate, derived from models or historical data.

The term “ranking” refers to an ordered arrangement of multiple candidates based on one or more evaluation indices, such that candidates are prioritized according to computed or assigned scores.

The term “information processing terminal” refers to an electronic device capable of processing data and interacting with a user, including but not limited to a portable terminal, a stationary terminal, a tablet device, or a similar computing appliance equipped with at least one display device or audio output device.

The term “display device” refers to a component of an information processing terminal that visually presents information, including but not limited to a liquid crystal display, an organic light-emitting display, or another visual output apparatus.

The term “audio output device” refers to a component of an information processing terminal that outputs sound, including but not limited to a speaker, an earphone, or another acoustic transducer.

The term “input device” refers to a component through which a subject or a supporter provides input to an information processing terminal, including but not limited to a touch-sensitive panel, a pointing device, a keyboard, or similar user interface hardware. The term “voice input device” refers to a component configured to receive spoken input, including but not limited to a microphone coupled with a voice recognition module or service. The term “selection result” refers to data indicating at least one care candidate or conversation candidate chosen by a subject or a supporter from among multiple presented candidates, including identifiers and associated selection metadata.

The term “care result information” refers to data representing outcomes observed after execution of a care candidate, including but not limited to changes in biological information, changes in behavior information, and qualitative assessments recorded by a supporter.

The term “conversation result information” refers to data representing outcomes of using a conversation candidate, including but not limited to response content, interaction success indicators, and user satisfaction signals.

The term “learning data” refers to data used to train or update one or more models, the data including at least associations between state feature information, context information, generated candidates, selection results, and subsequent outcomes.

The term “prediction model” refers to a computational model used by a processor to infer or estimate, from input features such as state feature information and context information, one or more outputs including rankings, evaluation indices, or control parameters for the generative AI model.

In one embodiment, a server, a terminal, and a user cooperate to implement the claimed system. The server includes at least one processor, a memory, a non-transitory storage device, and a network interface. The terminal includes at least one processor, a display device, an audio output device, at least one input device such as a touch-sensitive panel, and optionally a microphone and camera. The user wears or uses multiple sensing devices such as a wearable vital sensor and an environmental sensor unit.

The server executes an operating system such as a general-purpose server operating system and runs application software including a data acquisition module, a feature extraction module, a prediction module, a prompt generation module, a generative AI interface module, an evaluation and ranking module, a feedback learning module, and an application programming interface (API) module. The server uses a relational database management system such as a generic SQL database to store time-series records of biological information, behavior information, care history information, conversation history information, and various context information. The server further uses a numerical computation library such as a matrix and tensor computation library, a machine learning library such as a gradient-based learning framework, and an audio analysis library for signal processing.

The terminal executes a mobile or desktop operating system and runs a client application that communicates with the server over a network such as a wireless local network or a wide area network. The terminal uses a graphical user interface framework to render care candidates and conversation candidates as interactive elements, and uses a speech recognition API and a text-to-speech API to handle voice-based interaction.

The user wears a wearable device such as a generic wrist-worn vital sensor that measures heart rate, body temperature, blood oxygen saturation, and motion. The user stays in an environment where environmental sensors such as microphones, beacons, and positioning devices are installed. A bed or chair used by the user may be equipped with pressure sensors and motion sensors to collect additional biological and behavior information.

Server acquires biological information, behavior information, care history information, and conversation history information from multiple sources. Server receives biological information and behavior information from the wearable device and bed sensors via a gateway or directly via a wireless communication protocol. For example, server receives time-stamped records of heart rate, body temperature, blood pressure, blood oxygen saturation, step counts, and sleep/wake states. Server receives care history information from the terminal when a supporter registers care actions such as medication administration, assisted walking, or guided breathing exercises. Server receives conversation history information from the terminal when the user or supporter selects conversation candidates or inputs free-form text that is stored as dialogue content.

Server uses a feature extraction module implemented in a numerical computation library to convert the time-series records into state feature information. Server calculates windowed statistics such as moving averages, variances, maximum and minimum values, and frequency of events over fixed intervals. Server converts categorical events such as “took medication A” or “completed exercise B” into one-hot or embedding representations. Server constructs temporal feature vectors that concatenate multiple time windows and multiple modalities, so that each feature vector represents a snapshot of the user's state over a specified duration. Server similarly constructs care effect feature information. Server associates each care action in the care history information with pre- and post-care biological information and behavior information within configurable time windows. Server computes differences and ratios of key vital signs and activity measures before and after each care action. Server labels each care action with a quantitative or categorical indicator of effect, for example improvement, no change, or deterioration. Server aggregates these indicators across multiple instances of the same care action to obtain care effect feature information such as empirical success rates and typical magnitude of change.

Server acquires position information, environmental sound information, activity amount information, and terminal operation information to generate current situation information and context information. Server receives position information in the form of room identifiers or coordinates derived from beacons and positioning devices. Server receives environmental sound information from terminal microphones or dedicated audio sensors. The environmental sound information includes sound level values and frequency-domain features. Server classifies the environment into categories such as quiet, moderate, and noisy using a classifier implemented in a machine learning library or a rule-based module that compares sound levels to thresholds and identifies periodic or impulsive patterns.

Server receives activity amount information from motion sensors and wearable devices in the form of step counts and acceleration statistics. Server classifies activity levels into categories such as resting, lightly active, walking, or vigorous movement. Server monitors terminal operation information including which user interface screens are active, which buttons are pressed, and how long the user or supporter stays on certain pages. Server stores these context variables in a context table with timestamps and user identifiers.

Server generates prompt sentences that will be input to a generative AI model. Server constructs each prompt sentence in a structured natural language format that includes a description of the user's current state and context, a summary of recent history, and explicit instructions about output format and constraints. For example, server may construct a prompt sentence such as:

“You are a care planning assistant. The following is the current and historical data of an elderly user who has communication difficulties. Data: Current vitals: heart rate 96 beats per minute, temperature 37.2° C., blood pressure 135 over 85, oxygen saturation 96 percent. Current context: in living room, environment is noisy, activity is sitting. Recent events: took morning medication at 09:00, reported mild dizziness at 09:30. History: 5 past episodes of dizziness; effective past care included ‘rest in a quiet room’ and ‘fluid intake’. Based on this information, generate 3 candidate care actions. For each candidate, output a title, a description, an urgency level (low, medium, or high), and a one-sentence rationale. Use concise language suitable for a caregiver and avoid recommending unavailable equipment.” As another example, server may construct a prompt sentence for conversation assistance such as:

“You are an assistive communication generator for a user with language impairment. The user is currently in the dining room, environment is quiet, and the user's recent vitals are stable. The user's past conversation history includes phrases about asking for water, asking to use the restroom, and expressing discomfort. Generate 3 short conversation candidates that the user might want to say in this context. For each candidate, provide a phrase that can be directly shown to a caregiver, an urgency level (low, medium, or high), and a short rationale referencing the context. Ensure that each phrase is polite and easy to understand.” Server inputs the prompt sentence, together with serialized state feature information and context information, to a generative AI model. In one embodiment, server hosts the generative AI model locally as a neural network implemented in a deep learning framework. The generative AI model may include a transformer-based language model with multiple self-attention layers, feedforward layers, and layer normalization. The model parameters are stored in the server's storage. In another embodiment, server accesses an external generative AI service over a network, where the prompt sentence is transmitted as text and the response is received as text.

Server configures the generative AI model to produce outputs that are constrained to a machine-interpretable structure. For example, server includes specific instructions in the prompt sentence requiring that each candidate be presented in a consistent pattern such as “Title: . . . ; Description: . . . ; Urgency: . . . ; Rationale: . . . “. Server then parses the output by tokenizing the generated text and extracting fields based on markers. In another embodiment, server requests the generative AI model to output a structured list format that can be parsed deterministically.

Server applies an evaluation and ranking module to the parsed candidates. Server defines evaluation indices including urgency, ease of execution, safety, and expected effect. Server may directly use the urgency levels output by the generative AI model, or may refine them using a prediction model trained on historical data. For example, server may implement a smaller neural network or gradient-boosted decision tree that takes as input the candidate type, required resources, user's current vitals, and historical outcomes, and outputs a predicted risk score and benefit score. Server combines the scores into a ranking score and orders the candidates accordingly.

Server transmits the ranked care candidates or conversation candidates to the terminal. Server includes, in the transmitted data, identifiers for each candidate, the fields of title, description, urgency level, rationale, and any internal evaluation indices. The terminal receives this data through the client application and renders the candidates as visual cards. The terminal shows urgency through color coding and icons, shows descriptions and rationales as text, and optionally uses the audio output device to read high-urgency candidates automatically. Terminal allows the user or a supporter to select one or more candidates using various input modalities. The terminal detects touch events on the touch-sensitive panel, processes gaze direction when an eye-tracking module is available, and processes voice commands through the microphone and speech recognition module. When a selection is made, terminal sends selection result information to the server. The selection result information includes a candidate identifier, a time stamp, and a terminal identifier, and may include additional notes entered by the supporter.

User experiences the selected care action or conversation content in the real world. For a care candidate, a supporter may follow the description presented on the terminal, such as moving the user to a quiet room, offering water, measuring blood pressure, or guiding breathing exercises. For a conversation candidate, terminal may show the phrase as large text or output it as synthesized speech, so that a caregiver or communication partner can understand the user's intention.

Server collects feedback after execution of a candidate. Server receives subsequent biological information and behavior information from sensors and wearable devices. Server analyzes changes in vital signs and activity levels relative to the baseline before the care action. Server also receives care result information and conversation result information when the supporter or user enters a qualitative assessment, such as “dizziness improved” or “user appeared satisfied with response.” Server stores these records as learning data, with explicit associations between initial state feature information, context information, generated candidates, selected candidate, and outcome metrics.

Server updates its prediction model and prompt generation strategy using the learning data. In one embodiment, server implements supervised learning where the loss function penalizes discrepancies between predicted effectiveness scores and observed outcomes. Server adjusts model weights by backpropagation with gradient descent or a variant such as Adam optimization. Server may use cross-validation or hold-out sets to avoid overfitting and may apply regularization techniques such as weight decay and dropout in the neural network layers.

Server updates care effect feature information by recomputing empirical success rates and effect distributions for each type of care action in each context cluster. Server uses this updated information in subsequent prompt sentences to guide the generative AI model toward actions that historically exhibited higher success for similar states and contexts. For example, server may modify the prompt sentence to include explicit statements such as “Past data indicate that in similar situations, ‘rest in a quiet room’ improved symptoms in 80 percent of cases, while ‘immediate exercise’ worsened symptoms in 30 percent of cases. Consider these statistics when proposing options.”

Server thereby implements a non-traditional processing pipeline that is not limited to static rule execution or simple threshold-based alerts. Instead, server constructs high-dimensional state representations and uses a generative AI model controlled via dynamically generated prompt sentences, followed by machine-based structuring, evaluation, and closed-loop learning. This configuration improves computer technology in several ways.

First, server reduces redundant processing and latency by unifying multimodal data into shared state feature information and context information structures, which are reused across modules. This reduces database queries and memory copies and improves cache efficiency. Second, server improves prediction accuracy by combining historical effectiveness data with generative proposals, so that the computation incorporates both pattern discovery and explicit outcome-driven weighting. Third, server enhances robustness and parsing accuracy by constraining generative outputs through structured prompt sentences and post-processing rules, thereby reducing errors in downstream modules and improving the reliability of automatic ranking.

Fourth, server improves computational efficiency by using evaluation indices and ranking to limit the number of candidates presented to the terminal. Instead of presenting an unbounded list of generated options, server selects a small number of high-scoring candidates, which reduces communication bandwidth and processing load on the terminal. Fifth, server enables adaptive prompt optimization, where the contents and structure of prompt sentences are updated based on actual system performance, leading to improved convergence of the overall pipeline and reduced need for manual system tuning.

Server applies learning methods that differ from conventional manual rule updates. For example, server may cluster states and contexts into latent classes using an unsupervised learning algorithm and then learn class-specific prompt templates. Server may apply data augmentation techniques, such as adding small noise to vital sign values or simulating slight timing variations, to increase the robustness of the prediction model. Server may use a composite loss function that balances prediction error, calibration of urgency levels, and stability of candidate ranking. These methods contribute to improved technical performance beyond simple automation of human decision making.

Alternative embodiments are possible. In one embodiment, server uses a recurrent neural network instead of a transformer-based model, where the network processes sequential state feature information over time to predict parameters that are injected into the prompt sentence, such as recommended number of candidates or risk thresholds. In another embodiment, server deploys the generative AI model at the edge, where the terminal itself runs a compact language model and the server only provides state feature information and updated model parameters. This variation can reduce network latency and improve responsiveness in environments with unstable connectivity.

In another embodiment, server uses alternative evaluation indices, such as energy consumption or device usage cost, when care actions require activation of additional equipment. Server may adjust ranking scores to favor actions that achieve similar expected effect with lower resource usage, thereby optimizing computational and physical resource management. In yet another embodiment, server employs different learning schedules for different user groups, where the update frequency and learning rate are adapted based on data volume and variability, which can further enhance stability and reduce oscillatory behavior in recommendation patterns.

Terminal may vary in form factor and capabilities. In one embodiment, terminal is a handheld device with limited processing power, relying heavily on the server for computation. In another embodiment, terminal is an all-in-one station in a care facility with more powerful processors, capable of local pre-processing and caching of candidate lists. Terminal may support different input modalities such as gesture recognition or switch-based input to accommodate users with severe motor impairments.

User may interact with the system passively, by simply wearing sensors and being observed, or actively, by selecting conversation candidates or giving feedback through the terminal. Regardless of the interaction style, server maintains consistent internal data structures and learning mechanisms, so that the computational pipeline remains unified and scalable. Through these configurations and variations, the system achieves technical effects including more accurate and context-aware generation of care and conversation candidates, faster adaptation to changing user conditions, reduced communication load between server and terminal, improved reliability of parsing and ranking generative outputs, and overall improved efficiency and robustness of the computer-implemented processing.

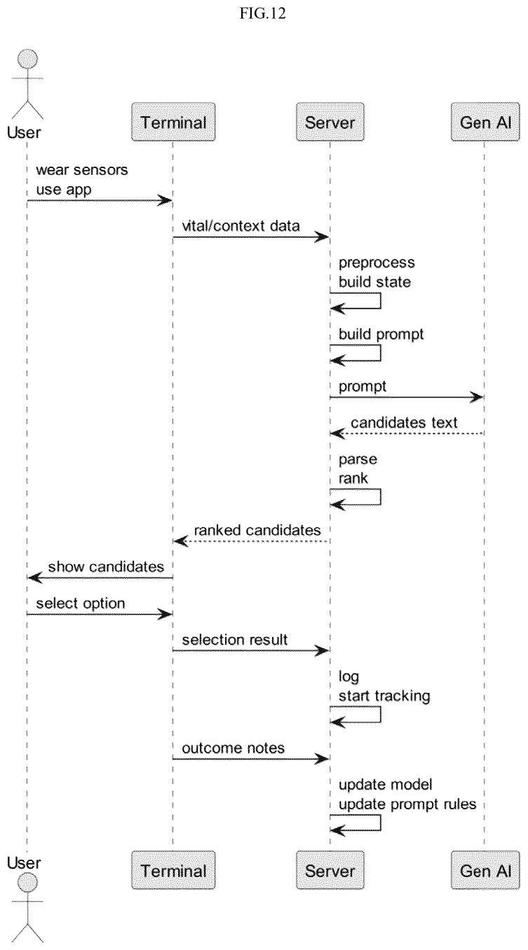

The following describes the processing flow using FIG. 12.

### Step 1:

Server acquires raw user-related data.

Server receives, as input, biological information (for example, heart rate, body temperature, blood pressure, oxygen saturation), behavior information (for example, step counts, sleep/wake states), care history information (for example, types and times of past care actions), and conversation history information (for example, selected phrases and dialogue logs) from sensors, wearable devices, and the terminal via network communication. Server writes the received records into time-series tables in a database, indexing each record by user identifier and timestamp. Server thereby outputs structured raw data entries that are ready for further processing.

### Step 2:

Terminal collects sensor readings and user interaction events.

Terminal receives, as input, signals from local hardware such as a wearable device SDK, an internal accelerometer, a microphone, and a touch-sensitive display. Terminal reads current vital sign samples, motion data, environmental sound snippets, and user interface events (for example, screen changes, button taps).

Terminal packages these signals as timestamped messages and transmits them to the server via a network protocol. Terminal thereby outputs formatted data packets that become part of the server's input in Step 1.

### Step 3:

User generates real-world signals and actions.

User provides, as input to the overall system, physiological signals (for example, changes in heart rate and temperature), physical activities (for example, walking, resting, sleeping), and interaction behavior (for example, attempting to communicate, responding to care). User's actions cause changes in sensor readings and terminal usage patterns. These changes are captured by devices and become the input data streams used by the server and terminal in subsequent steps, forming the basis for state estimation and prediction outputs.

### Step 4:

Server preprocesses and cleans time-series data.

Server retrieves, as input, raw biological information, behavior information, care history information, and conversation history information from the database. Server removes invalid values (for example, impossible vital values), fills small gaps by interpolation, and aligns timestamps across different data sources.

Server applies time-windowing operations (for example, per 5-minute or 1-hour windows) and computes basic statistics such as average heart rate, variance of activity levels, and counts of care events per window. Server outputs normalized and temporally aligned data structures that serve as input to feature extraction.

### Step 5:

Server generates state feature information.

Server takes, as input, the cleaned and aligned time-series data from Step 4. Server combines multiple modalities (vital signs, activity, care events, conversation events) into feature vectors by concatenating numerical features and encoded categorical features (for example, one-hot or embedding indices for event types).

Server computes derived features such as trend indicators (for example, increasing or decreasing heart rate), time-of-day encodings (for example, morning, afternoon, night), and frequency of specific symptoms or requests. Server outputs state feature information, which is represented as high-dimensional vectors associated with each user at specific times.

### Step 6:

Server generates care effect feature information.

Server receives, as input, care history information and subsequent outcome data (for example, vital sign changes and behavior changes after each care action). Server identifies time windows before and after each care action and computes differences and ratios for relevant measures (for example, heart rate before versus after rest, activity level before versus after exercise).

Server aggregates these per-action effects over multiple occurrences of the same type of care and calculates empirical success rates, average improvement magnitudes, and variability. Server outputs care effect feature information that encapsulates historical effectiveness patterns for each care action type.

### Step 7:

Server acquires context information.

Server takes, as input, position information (for example, room identifiers or coordinates), environmental sound information (for example, sound level and classification), activity amount information (for example, steps and movement intensity), and terminal operation information (for example, current screen and recent actions).

Server applies classification algorithms or rule-based logic to categorize environment state (for example, quiet, moderate, noisy) and activity state (for example, resting, lightly active, walking). Server fuses these values into a context record with fields such as room, noise level, activity category, and terminal usage pattern. Server outputs current situation information and context information associated with the user and timestamp.

### Step 8:

Server composes a structured state and selects relevant history.

Server receives, as input, state feature information from Step 5, care effect feature information from Step 6, and context information from Step 7 for a given user and current time. Server selects a recent time horizon (for example, last 24 hours) and summarizes key events such as recent symptoms, care actions, and conversation attempts.

Server constructs a structured state object that includes current vitals, environment labels, activity state, and history summaries (for example, number of recent dizziness episodes and previously effective care types). Server outputs this structured state object for use in prompt sentence generation.

### Step 9:

Server generates a prompt sentence for a generative AI model.

Server takes, as input, the structured state object from Step 8. Server converts numerical and categorical fields into human-readable phrases, embeds them into a template, and concatenates them into a coherent natural-language instruction.

For example, server outputs a prompt sentence such as:

“You are a care planning assistant. The following is the current and historical data of an elderly user who has communication difficulties. Data: Current vitals: heart rate 96 beats per minute, temperature 37.2° C., blood pressure 135 over 85, oxygen saturation 96 percent. Current context: in living room, environment is noisy, activity is sitting. Recent events: took morning medication at 09:00, reported mild dizziness at 09:30. History: 5 past episodes of dizziness; effective past care included ‘rest in a quiet room’ and ‘fluid intake’. Based on this information, generate 3 candidate care actions. For each candidate, output a title, a description, an urgency level (low, medium, or high), and a one-sentence rationale, and avoid recommending unavailable equipment.”

Server outputs this prompt sentence as text, ready to be sent to the generative AI model.

### Step 10:

Server invokes the generative AI model.

Server uses, as input, the prompt sentence generated in Step 9 and optionally serialized state and context details. Server passes these inputs to a generative AI model implemented as a neural network (for example, a transformer-based language model) running locally or provided via an external API.

Server receives, as output, generated text containing multiple proposed care candidates or conversation candidates, structured according to the instructions in the prompt sentence (for example, repeated “Title/Description/Urgency/Rationale” patterns). This output text becomes the input for downstream parsing and evaluation.

### Step 11:

Server parses and structures the generated candidates.

Server takes, as input, the generated text from the generative AI model. Server tokenizes the text, locates field markers (for example, “Title:”, “Description:”, “Urgency:”, “Rationale:”), and extracts the corresponding segments.

Server builds a structured representation (for example, internal records or objects) for each candidate, assigning fields such as candidate identifier, title string, description string, urgency label, and rationale string. Server outputs a list of structured care candidates or conversation candidates, each expressed as a machine-interpretable record.

### Step 12:

Server evaluates and ranks the candidates.

Server receives, as input, the list of structured candidates from Step 11 and the current state feature information and context information from previous steps. Server optionally incorporates care effect feature information to assess how similar candidates have performed historically in similar contexts.

Server computes evaluation indices such as urgency, ease of execution, safety, and expected effect. For example, server may map urgency labels to numeric scores, adjust safety based on contraindications inferred from current vitals, and adjust expected effect using learned models trained on past outcomes. Server calculates a composite ranking score for each candidate and sorts the list accordingly. Server outputs a ranked candidate list with attached evaluation indices.

### Step 13:

Server stores candidate records and prepares display data.

Server takes, as input, the ranked candidate list and evaluation indices. Server writes these candidate records into a database table, including user identifier, generation time, candidate content, and ranking information.

Server creates a display payload that includes only necessary fields (for example, title, brief description, urgency, and short rationale) and compresses or filters data to reduce network load. Server outputs a compact, ranked candidate payload targeted for the terminal.

### Step 14:

Terminal retrieves and displays candidates.

Terminal receives, as input, the ranked candidate payload from the server. Terminal renders each candidate as an interactive UI element on the display device, showing title, description, urgency indicator, and rationale.

Terminal sorts and visually emphasizes candidates according to their ranking scores (for example, placing high-urgency actions at the top and coloring them differently). Terminal outputs a graphical interface where the user or supporter can easily perceive and compare the presented options.

### Step 15:

Terminal receives selection input from user or supporter.

Terminal takes, as input, user actions such as touch gestures, eye-gaze confirmation, or voice commands. Terminal maps each action to the corresponding candidate identifier (for example, “Candidate 1 selected”).

Terminal constructs a selection result message containing user identifier, selected candidate identifier, timestamp, and optional comments entered by the supporter. Terminal outputs this selection result to the server over the network.

### Step 16:

Server records selection results and initiates execution tracking.

Server receives, as input, the selection result from the terminal. Server links the selection result with the previously stored candidate record, state feature information, and context information at the time of generation.

Server writes an execution entry in an execution table, including selected candidate, selection time, and any immediate notes. Server outputs an updated data state that reflects which candidate has transitioned from “proposed” to “selected” and will be monitored for outcomes.

### Step 17:

User undergoes the selected care action or uses the selected conversation candidate. User experiences, as input, the real-world actions carried out based on the selected care candidate (for example, being moved to a quiet room, receiving water, or being guided through exercises), or sees/hears the selected conversation candidate presented to a communication partner.

User's physiological and behavioral responses to these actions (for example, changes in vital signs, changes in activity levels, and observable comfort) become the next set of signals captured by sensors and terminal interactions. User thereby generates output signals that feed back into the data acquisition processes in earlier steps.

### Step 18:

Server acquires outcome data and computes care and conversation results.

Server receives, as input, subsequent biological information and behavior information after the selected candidate has been executed, as well as any care result information and conversation result information entered through the terminal. Server identifies pre- and post-execution windows around the selection time.

Server computes outcome metrics such as differences in heart rate, stability of blood pressure, reduction in reported symptoms, or positive interaction markers. Server labels the execution result (for example, improved, unchanged, or worsened) based on thresholds or learned classifiers. Server outputs outcome records linked to the executed candidate.

### Step 19:

Server updates learning data and prediction models.

Server uses, as input, associations between state feature information, context information, generated candidates, selection results, and outcome records accumulated over multiple executions. Server forms training batches where inputs are state and context representations and targets are observed outcome indicators or optimality labels.

Server adjusts parameters of prediction models (for example, neural networks or other machine learning models) by computing loss values (for example, cross-entropy or mean squared error) and applying gradient-based optimization. Server also analyzes which prompt sentence patterns produced candidates with higher success rates and updates prompt templates accordingly. Server outputs updated model parameters and refined prompt generation rules.

### Step 20:

Server refines future prompt sentences and candidate generation behavior.

Server takes, as input, updated models, care effect feature information, and prompt template definitions. Server modifies the prompt generation logic so that future prompt sentences explicitly highlight historically effective actions and de-emphasize ineffective or unsafe ones. Server may, for example, output new prompt sentences of the form:

“Past data indicate that, in similar situations, ‘rest in a quiet room’ improved dizziness in 80 percent of cases and ‘intense activity’ worsened symptoms in 30 percent of cases. Based on the current state and context, generate 3 safe and feasible care actions, prioritizing those with historically higher success.”

By doing so, server outputs prompt sentences and internal control parameters that cause the generative AI model to produce candidates that are better aligned with learned effectiveness patterns, thereby closing the feedback loop and improving system performance over time.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional communication support systems for users with speech or language impairments generally rely on static phrase lists or simple next-word prediction models that are driven primarily by lexical co-occurrence or limited context attributes such as time or location. Such systems typically operate with shallow scoring logic executing on a general-purpose processor, and do not integrate multimodal emotional state estimation, rich user-preference modeling, or dynamic presentation control. As a result, the underlying computer processes for candidate generation, ranking, and user interface adaptation are sub-optimal in terms of how effectively they transform available sensor data and historical interaction data into high-utility outputs.

In particular, known systems suffer from several technical limitations in computer operation. First, the prediction of conversation candidates is usually performed with generic language models or rule-based mechanisms that are not tightly coupled with user-specific feedback data. The computing device does not maintain or update a structured user model that encodes vocabulary tendencies, expression styles, and emotion-dependent selection tendencies, and therefore cannot efficiently bias generative processes toward content that is likely to be selected. This leads to unnecessary compute cycles spent on generating and transmitting numerous low-relevance candidates, which in turn increases bandwidth usage and processing latency on both server and client devices.

Second, context acquisition in many systems is limited to basic metadata and does not exploit systematic integration of multimodal signals. Processors often treat location, time, and environmental sound in isolation and do not unify them with image-based and behavior-based features to estimate the user's emotional state. Without such multimodal fusion, the computing pipeline cannot accurately characterize the user's internal state, and cannot adapt the number, complexity, and presentation format of conversation candidates to match the user's current cognitive and emotional load. This results in inefficient use of display resources and interaction channels, such as presenting too many or too few options, or using inappropriate layout density, thereby degrading the effectiveness of the user interface processing.

Third, feedback from user selections is frequently used only in a rudimentary way, for example as simple counters of phrase usage. The computing device does not maintain structured feedback records that couple each selection event with contemporaneous context, emotional state, and detailed operation log metrics such as selection latency and scroll distance. Moreover, conventional systems do not use a generative AI model as a meta-analyzer of such feedback data to discover latent preference patterns and encode them as machine-interpretable features. As a result, the learning loop that updates ranking models and user models is weakly coupled to actual user behavior, and the computational resources devoted to learning are not effectively converted into measurable improvements in ranking quality and interface adaptation.

Fourth, existing approaches treat the generative AI model as a black-box text generator and do not formalize the construction of prompt sentences that explicitly include structured user models, context descriptions, and emotional state summaries. Without such structured prompt sentences, the generative AI model is forced to infer missing conditions implicitly, which can increase generation variance, reduce reliability of outputs, and waste compute cycles on the accelerator hardware due to repeated generation and post-filtering to achieve acceptable results. This also complicates downstream scoring and may require additional ad-hoc filtering processes, further increasing computational overhead.

Accordingly, there is a need for a technical solution that re-architects the computer processing pipeline itself: (i) to construct and update a user model, a ranking model, and an emotional state estimation model in a coordinated manner using deep learning frameworks on matrix computation hardware; (ii) to acquire and fuse multimodal sensor and log data into context and emotion representations; (iii) to construct rich prompt sentences that explicitly condition a generative AI model on those representations; and (iv) to drive dynamic candidate presentation control and model updates based on structured feedback data. Such a solution should improve the efficiency and effectiveness of the underlying computing processes for generating, scoring, presenting, and adapting conversation candidates, thereby providing a concrete improvement in computer technology rather than merely automating human judgment.

The specific processing by the specific processing unit 290 of the data processing device 12 in Example 2 is realized by the following means.

The present invention provides a server comprising a processor configured to learn, using a deep learning library and a matrix computation device, linguistic tendencies and expression tendencies of a user based on conversation history information and preference information, so as to construct and update a user model; acquire, from an information processing apparatus operated by the user, position information, time information, and environmental sound information, and generate context information indicating a situation in which the user is placed; estimate an emotional state of the user by fusing a plurality of types of feature quantities extracted from an imaging apparatus, a sound acquisition apparatus, and operation log information, and record the estimated emotional state as emotion history information; construct a prompt sentence including at least the user model, the context information, and the emotional state together with an instruction sentence and auxiliary information, and input the prompt sentence to a generative AI model that is a natural language text generation model, thereby causing the generative AI model to generate a plurality of conversation candidates that the user is likely to want to utter next; calculate, for each of the plurality of conversation candidates, a score based on at least one of past selection history of the user, the context information, and the emotional state, determine a presentation mode including at least a number of candidates to present, a display format, and a degree of emphasis according to the score and the emotional state, and transmit the plurality of conversation candidates together with the presentation mode to the information processing apparatus; acquire, from the information processing apparatus, a selected conversation candidate selected by the user via at least one of gaze input, touch input, and voice input, and acquire associated operation log information including at least an elapsed time from candidate presentation to selection, a number of operations, and a screen scroll amount; and store, as feedback data, at least the selected conversation candidate, the operation log information, the context information corresponding to a time of selection, and the emotional state corresponding to the time of selection, and update, based on the feedback data, at least part of the user model, a ranking model for the conversation candidates, and an emotional state estimation model by executing forward propagation computation and backpropagation computation of a neural network model, and further input a plurality of pieces of the feedback data and corresponding context information and emotional states to the generative AI model as a meta-level prompt sentence to obtain a description result indicating preference tendencies and incorporate features extracted from the description result into at least one of the user model and the ranking model. This enables the computing device to more efficiently utilize multimodal sensor data and interaction logs to condition the generative AI model, to reduce unnecessary candidate generation and filtering, to dynamically adapt the number and format of presented candidates to the user's current emotional and contextual state, and to continuously refine internal models based on structured feedback, thereby improving the technical performance of the conversation candidate generation, ranking, and presentation processes executed by the server and the information processing apparatus.

The term “user” refers to an individual who operates the information processing apparatus and for whom conversation candidates are generated, including a person having a speech or language impairment that makes spontaneous verbal communication difficult. The term “conversation history information” refers to data representing past utterances associated with the user, including at least text of utterances, corresponding responses, timestamps, communication partners, and optionally associated context and emotional state information.

The term “preference information” refers to data representing user-specific tendencies and likes, including at least frequently selected expressions, stylistic preferences, and patterns of candidate selection under different contexts and emotional states.

The term “linguistic tendencies” refers to statistical characteristics of the user's language use, including at least preferred vocabulary, phrasing, sentence structure, and typical progression of utterances.

The term “expression tendencies” refers to stylistic features of the user's utterances, including at least politeness level, degree of formality, sentence length, and emotional tone.

The term “user model” refers to a data structure or machine learning model that encodes at least linguistic tendencies, expression tendencies, and selection tendencies of the user, and that is trained or updated based on conversation history information, preference information, and feedback data.

The term “information processing apparatus” refers to a computing device operated by the user and communicatively connected to the server, the computing device including at least a display unit, an input unit, and one or more sensors such as a position sensor, an imaging apparatus, and a sound acquisition apparatus.

The term “position information” refers to information indicating a geographic location of the information processing apparatus, including at least coordinate information and optionally a derived place type.

The term “time information” refers to information indicating a time at which an event occurs, including at least a date, a time of day, and optionally a time-of-day classification. The term “environmental sound information” refers to acoustic signal data or features derived from sound acquired by the sound acquisition apparatus, including at least noise level, presence of speech, and spectral characteristics indicative of an environment type. The term “context information” refers to high-level information representing a situation in which the user is placed, obtained by integrating at least position information, time information, and environmental sound information, and optionally including a place type label, a time-of-day label, and an environment label.

The term “imaging apparatus” refers to an image acquisition device, such as a camera or image sensor, configured to capture images including at least a face region of the user. The term “sound acquisition apparatus” refers to an acoustic sensor, such as a microphone or microphone array, configured to capture sound including at least environmental sounds and optionally user speech.

The term “operation log information” refers to information indicating user interactions with the information processing apparatus, including at least touch operations, gaze interactions, scroll operations, and temporal information about those operations.

The term “feature quantities” refers to numerical representations extracted from raw sensor data or logs, including at least facial landmark coordinates from images, acoustic features from sound, and behavioral features from operation logs.

The term “emotional state” refers to information representing the user's psychological or affective condition, including at least one emotion category, such as joy, sadness, anxiety, anger, tension, or relaxation, and an intensity or stress level associated with the category.

The term “emotion history information” refers to a time-series record of estimated emotional states associated with the user, including at least timestamps, emotion categories, and intensities or stress levels.

The term “generative AI model” refers to a machine learning model, such as a generative language model, configured to generate natural language text outputs based on an input sequence, and trained using large-scale text data.

The term “prompt sentence” refers to an input text supplied to the generative AI model, the input text including at least an instruction sentence, auxiliary information, and structured information such as the user model, the context information, and the emotional state. The term “conversation candidate” refers to a text expression, such as a phrase or sentence, that is generated by the generative AI model and is predicted to be a likely next utterance that the user may want to produce.

The term “past selection history” refers to records of conversation candidates that were previously presented to and selected by the user, including at least candidate identifiers, texts, contexts, and emotional states at selection times.

The term “score” refers to a numerical value computed for each conversation candidate, based on at least the past selection history, the current context information, and the current emotional state, and used for ranking and presentation control.

The term “presentation mode” refers to parameters defining how conversation candidates are presented on the information processing apparatus, including at least a number of candidates to present, a display format, and a degree of emphasis for one or more candidates.

The term “gaze input” refers to an interaction modality in which a gaze tracking mechanism detects a direction or fixation of the user's line of sight, and the detection result is interpreted as an input to select or interact with a conversation candidate.

The term “touch input” refers to an interaction modality in which contact with a touch-sensitive surface of the information processing apparatus is detected and mapped to selection or manipulation of a conversation candidate.

The term “voice input” refers to an interaction modality in which speech of the user is captured by the sound acquisition apparatus, processed by a speech recognition component, and interpreted as commands for selecting or controlling conversation candidates.

The term “elapsed time from candidate presentation to selection” refers to a time interval measured between a time when conversation candidates are first displayed on the information processing apparatus and a time when the user selects one of the conversation candidates.

The term “number of operations” refers to a count of input actions performed by the user on the information processing apparatus, including at least taps, gaze-based focus confirmations, or voice commands, in a period from candidate presentation to selection.

The term “screen scroll amount” refers to a measure of scrolling movement performed on a display of the information processing apparatus while the user is viewing and navigating through conversation candidates.

The term “feedback data” refers to structured data including at least a selected conversation candidate, operation log information associated with the selection, the context information corresponding to a selection time, and the emotional state corresponding to the selection time. The term “ranking model” refers to a machine learning model configured to output, for a given context and emotional state and for a set of conversation candidates, ranking scores indicating likelihood of selection or suitability of the conversation candidates.

The term “emotional state estimation model” refers to a machine learning model configured to estimate the emotional state of the user from multimodal feature quantities including at least image-based, sound-based, and behavior-based features.

The term “deep learning library” refers to a software library configured to define, train, and execute neural network models using operations such as tensor algebra, automatic differentiation, and parallel batch computation.

The term “matrix computation device” refers to a hardware component or subsystem optimized for vector and matrix operations, such as a graphics processing unit, a tensor accelerator, or a specialized neural network processor.

The term “forward propagation computation” refers to a process in a neural network model in which input data is passed through successive layers to produce output values based on current model parameters.

The term “backpropagation computation” refers to a process in a neural network model in which gradients of a loss function with respect to model parameters are computed by propagating error information backward through the model, thereby enabling parameter updates.

The term “meta-level prompt sentence” refers to a prompt sentence supplied to the generative AI model that describes, in abstracted or summarized form, multiple pieces of feedback data, context information, and emotional states, and that instructs the model to output higher-level descriptions of user preference tendencies.

The term “description result indicating preference tendencies” refers to natural language text output by the generative AI model in response to a meta-level prompt sentence, the text including at least human-readable statements describing how the user tends to select expressions under specific contexts and emotional states.

The term “features representing the preference tendencies” refers to machine-interpretable attributes derived from the description result, including at least indicators related to politeness level, sentence length, emotional polarity, and suitability under specific emotional or contextual conditions.

In the following embodiments, a server, a terminal, and a user cooperate to implement the claimed system. The same reference concepts may be embodied by different hardware and software configurations without departing from the scope of the claims.

### A. Overall System Configuration and Hardware Platform

Server operates as a centralized computation node. Server comprises at least one general-purpose processor (CPU), at least one matrix computation device such as a graphics processing unit (GPU) or dedicated tensor accelerator, a main memory, a non-volatile storage device, and a network interface. Server executes an operating system such as a general-purpose server operating system and runs application programs implementing the learning functions, context and emotion estimation functions, prompt sentence construction, generative AI model execution, ranking, feedback processing, and model update. Server uses a deep learning library such as a general-purpose deep learning framework (for example, a framework equivalent to PyTorch or TensorFlow) to define and execute neural network models, and uses a natural language processing library such as a general-purpose transformer library (for example, a library equivalent to Hugging Face Transformers) to tokenize text and run a generative AI model. Server uses a relational database management system such as a general-purpose relational database to store conversation history information, emotion history information, feedback data, and user models.

Terminal operates as a user-facing information processing apparatus. Terminal comprises a CPU, a memory, a display device, an input device such as a touch-sensitive panel or physical buttons, an imaging apparatus such as a camera, a sound acquisition apparatus such as a microphone, a position sensor such as a satellite positioning receiver, and a communication interface. Terminal executes a mobile or desktop operating system and a client application for communication support.

Terminal uses an image processing library such as a general-purpose computer vision library (for example, a library equivalent to OpenCV) and a facial landmark analysis framework (for example, a framework equivalent to MediaPipe or Dlib) to extract facial feature quantities from camera images. Terminal uses an audio analysis library such as a general-purpose audio processing library (for example, a library equivalent to Librosa) or an external speech recognition front-end to extract acoustic feature quantities. Terminal optionally connects to a gaze tracking device and uses a vendor-supplied gaze tracking software development kit to obtain gaze coordinates and dwell times.

User operates the terminal and interacts with conversation candidates by visual inspection, touch input, gaze input, and optionally voice commands. User may have a speech or language impairment that makes spontaneous spoken conversation difficult; however, the system is not limited to such users.

### B. Data Structures and Models

Server maintains, in the relational database, at least the following logical tables:

Server maintains a user table including a user identifier, a user model identifier, and static profile attributes.

Server maintains a conversation history table including, for each user identifier, records of utterances and responses, each record including at least: a timestamp, a speaker role (user or partner), a text field, a context identifier, and optionally an emotion state identifier.

Server maintains an emotion history table including, for each user identifier, time-stamped emotional state records, each record including at least: an emotion category label, an intensity or stress level, and links to context identifiers.

Server maintains a feedback table including, for each user identifier, records of conversation candidates that were presented and selected, each record including at least: a candidate identifier, candidate text, presentation time, selection time, elapsed time between presentation and selection, number of operations, screen scroll amount, context labels, and emotional state at selection.

Server maintains a context store including, for each user identifier and time period, a place type label (for example, home, shop, medical facility), a time-of-day label (for example, morning, afternoon, night), and an environment label (for example, quiet, medium noise, loud noise).

Server maintains a user model as a parameter vector or parameter set of a neural network that encodes linguistic tendencies, expression tendencies, and selection tendencies of the user. In one embodiment, server implements the user model as a dense embedding vector of fixed dimension associated with each user identifier, stored in a parameter matrix and updated during training.

Server maintains a ranking model configured to output, for a given context vector, emotional state vector, and a set of candidate embeddings, ranking scores indicating likelihood that each candidate will be selected. In one embodiment, server implements the ranking model as a feed-forward neural network with fully connected layers taking concatenated feature vectors as input.

Server maintains an emotional state estimation model configured to estimate emotion categories and stress levels from multimodal inputs. In one embodiment, server implements this model as a multimodal neural network comprising:

Server uses a convolutional or residual sub-network to process facial landmark-derived features.

Server uses a recurrent or transformer-based sub-network to process a sequence of acoustic frame features.

Server uses a fully connected sub-network to process behavioral features from operation logs. Server concatenates intermediate feature vectors from these sub-networks and applies one or more fully connected layers followed by a softmax layer for classification and a separate regression output for stress level.

Server maintains a generative AI model as a transformer-based generative language model. Server loads a pre-trained transformer network characterized by: multiple self-attention layers, position-wise feed-forward layers, layer normalization, and a token embedding matrix. Server assigns this model the role of generating conversation candidates and, in certain embodiments, analyzing summarized feedback data at a meta level.

### C. Learning and Model Update Processing

Server uses the deep learning library to implement training loops for the user model, ranking model, and emotional state estimation model. Server defines loss functions for these models as follows.

Server defines, for the ranking model, a loss function such as a cross-entropy loss over a softmax of scores for candidates, or a pairwise ranking loss that penalizes cases where a non-selected candidate receives a higher score than a selected candidate.

Server defines, for the emotional state estimation model, a combined loss function including: (i) a categorical cross-entropy loss between predicted emotion category probabilities and ground-truth labels, and (ii) a mean-squared error loss for the predicted stress value relative to a target stress value.

Server defines, for user embeddings and user-specific parameters, regularization terms such as L2 norms to avoid overfitting.

Server uses mini-batch stochastic gradient descent or an adaptive optimizer such as a variant of the Adam algorithm to update model parameters. Server computes gradients via backpropagation implemented by the deep learning library.

Server uses feedback data to form training examples. For each selection event, server constructs a training tuple containing: the context vector, emotional state vector, feature vectors of candidates that were presented, an indicator of which candidate was selected, and operation log features. Server uses this tuple to update ranking model parameters and to adjust user embedding vectors so that selected candidates receive higher predicted scores under similar contextual and emotional conditions in the future.

Server updates the emotional state estimation model using labeled emotional state data. In some embodiments, server uses supervised labels provided by human annotation or semi-automatic labeling based on multimodal patterns. Server combines historical feature sequences with labels to train the multimodal network.

By using structured feedback data and multimodal feature vectors in this way, server changes internal parameter values such that subsequent inference operations on the matrix computation device require fewer compute steps to achieve a desired accuracy, and such that the ranking and emotion estimation results show reduced error rates. This leads to reduced number of generated candidates, reduced need for repeated generation cycles, and lower communication load between server and terminal.

### D. Context and Emotional State Estimation

Server receives, from terminal, structured data including at least: position information, time information, environmental sound features, facial feature quantities, and operation log information.

Server converts position information (latitude, longitude) into a place type by performing a lookup in a geographic information data store. For this, server computes point-in-polygon operations or nearest-neighbor queries using spatial indices, and maps a coordinate to a place category label.

Server maps time information to a time-of-day label by applying threshold rules on clock values. For example, server classifies times before noon as “morning,” times between noon and early evening as “afternoon,” and later times as “night.”

Server analyzes environmental sound feature quantities by applying clustering or threshold algorithms on noise level and spectral energy distribution, thereby deriving environment labels such as “quiet,” “medium noise,” and “loud noise.” Server may also classify specific sound patterns such as “crowd noise” or “traffic noise.”

Server forms a context vector by encoding the place type, time-of-day label, and environment label into categorical embeddings and concatenating them with scalar features such as approximate decibel levels.

Server processes facial feature quantities (for example, normalized landmark positions, distances, and angles) using the image sub-network of the emotional state estimation model. Server processes audio feature quantities (for example, Mel-frequency cepstral coefficients, pitch contours, and energy statistics) using the acoustic sub-network. Server processes operation log information (for example, current tap rate or recent delay patterns) using the behavioral sub-network.

Server concatenates internal hidden vectors from these sub-networks and applies fully connected layers, followed by a softmax, to output emotion category probabilities. Server obtains a stress score from a regression head. Server then stores, in the emotion history table, an emotion category and intensity linked to the time and context, allowing later queries by time or context ranges.

Because server combines multiple sensor modalities in a single neural network with learned fusion weights, server can more accurately and robustly estimate emotional state than via simple threshold rules. This improved estimate, in turn, permits server to more aggressively adjust the number and complexity of presented candidates, thereby reducing user cognitive load and system resource usage.

### E. Prompt Sentence Construction and Generative AI Model Usage

Server constructs a prompt sentence for the generative AI model by assembling text segments that include: (i) a description of the role of the generative model, (ii) the conversation history information, (iii) the context information, (iv) the emotional state, and (v) explicit instructions regarding output format and constraints.

In one embodiment, server generates a prompt sentence as follows:

“You are a conversation-candidate generation engine that supports a user with a speech impairment.

The following information is given.

### [Conversation History]

User: Good morning.

Partner: Good morning. What would you like to drink today?

### [Current Context Information]

The user is now in a café in the morning with a medium level of background noise.

### [Current Emotional State]

The user is relaxed and has low stress.

Considering this information, generate five short Japanese utterance candidates that the user is likely to want to say next.

Each candidate should have low psychological burden for the user and should take the current emotional state into account.

Output format:
1.-
2.-
3.-
4.-
5.-”

Server tokenizes this prompt sentence into a sequence of subword tokens using the natural language processing library and transmits the token sequence to the generative AI model running on the GPU. The generative AI model then performs forward computations across multiple transformer layers, applying self-attention mechanisms that consider the entire context of the prompt. Server configures decoding parameters such as maximum output length, sampling temperature, and top-k or top-p values, thus controlling diversity versus determinism.

Server decodes the generated token sequence back into text and parses the numbered list to obtain individual candidate strings and candidate identifiers. Server then computes, using the ranking model and additional heuristics, numeric scores for each candidate. These operations reduce the need for manual curation or rule-based filtering of phrases and exploit high-dimensional language patterns captured by the generative AI model, while still being tightly constrained by explicit context and emotion conditions encoded in the prompt sentence.

### F. Dynamic Candidate Ranking and Presentation Adaptation

Server embeds each candidate text into a vector representation by either using an encoder component of the generative AI model or a separate sentence embedding model. Server combines each candidate embedding with the context vector, emotional state vector, and user embedding. Server inputs the concatenated vector to the ranking model to obtain a scalar score for each candidate.

Server orders candidates by score and applies rule sets that depend on emotional state and stress level. For high stress levels, server restricts the number of candidates to a small subset (for example, top two or three) and signals a presentation mode with large font sizes and increased spacing. For low stress levels, server permits more candidates (for example, five or more) and uses a compact but legible layout.

Server packages candidate texts, scores, and presentation mode metadata into a message and transmits it to terminal. Because server filters and orders candidates before transmission, server minimizes network bandwidth usage and reduces rendering complexity on terminal. As a result, terminal requires less processing time to display candidates, and the interaction latency experienced by user decreases.

Terminal receives the candidate list and associated display parameters. Terminal maps presentation mode metadata to user interface settings of a general-purpose UI framework, adjusting font size, card size, and spacing. Terminal then renders the UI elements on the display.

Terminal tracks user interactions via touch, gaze, and voice. Terminal records, in operation logs, tap coordinates, gaze dwell times, and recognized voice commands. Terminal maps these inputs to candidate selections without performing heavy semantic analysis, relying instead on explicit mapping logic. Terminal thus operates with relatively low CPU load. Terminal transmits selected candidate identifiers and detailed operation log information back to server. Because server centralizes learning and ranking, terminal can remain a lightweight client.

### G. Meta-Level Use of the Generative AI Model for Feedback Analysis

Server aggregates multiple feedback records and corresponding context and emotional state descriptions and constructs a meta-level prompt sentence. In one embodiment, server uses a prompt sentence such as:

“The following data shows conversation candidates presented to a user with a speech impairment,

the candidates actually selected, and the associated emotional states and contexts.

From this data, list in Japanese, as bullet points, the characteristics of expressions that the user prefers

depending on emotion and context (for example, polite/casual, short/long, positive/neutral).” Server then appends structured summaries of multiple feedback examples under this instruction and submits the resulting text to the same generative AI model. The generative AI model produces natural language descriptions such as:

“Under high stress, the user tends to select short and simple polite expressions.

In relaxed conditions, the user tends to select more casual and longer expressions that include small talk.”

Server parses these descriptions using simple pattern matching, semantic parsing, or keyword extraction to produce structured features: for example, a real-valued preference weight for sentence length under each emotional state, and a preference for politeness or casualness. Server then assigns these features as additional inputs or parameters in the ranking model and user model.

By using the generative AI model in this meta-analytic fashion, server transforms a large volume of raw feedback records into compact, human-interpretable rules and then into machine-interpretable features. This processing is distinct from conventional manual rule designer work and permits faster adaptation and more complex patterns than could feasibly be encoded by human engineers. Furthermore, because server formalizes these patterns as parameters in trained models, subsequent model inferences become computationally efficient.

### H. Technical Effects and Improvement of Computer Technology

Server improves computer technology in several ways.

Server reduces compute and communication overhead by tightly coupling user-specific feedback with generative candidate creation and ranking. Instead of generating large numbers of generic candidates and filtering them via simple heuristics, server conditions the generative AI model with rich prompt sentences that reflect user model, context, and emotional state. As a result, server generates fewer but more relevant candidates, reducing average output length and generation iterations, thus lowering GPU utilization and lowering network traffic. Server improves accuracy of emotional state estimation by training a multimodal neural network that fuses facial landmark features, acoustic features, and operation log features. The use of learned fusion weights and deep architectures improves classification accuracy and stress estimation accuracy relative to rule-based or unimodal methods. Improved emotional state estimation leads to better control of candidate number and layout density, which in turn reduces the expected time and number of actions required for user to select a suitable candidate.

Server provides a structured feedback loop where detailed operation log metrics (selection latency, scroll distance, operation counts) are systematically encoded as features in the ranking and user models. This allows server to detect subtle patterns such as “slow selection under many candidates” or “frequent scrolling for certain phrasing styles,” which cannot easily be exploited by simple count-based approaches. Training with these features enables models to converge to parameter values that minimize user effort in subsequent interactions, effectively optimizing selection time and error rates.

Server modifies the internal computation graph of the neural network models by frequently updating parameters based on new feedback. This dynamic adaptation optimizes the mapping from input features to scores and from multimodal features to emotional state labels. The technical effect manifests as a lower loss function value for prediction tasks, measurable decreases in prediction error, and lower variance in generation and ranking outcomes. Server uses the generative AI model not only as a direct text generator but also as an analytic engine to compress high-dimensional behavioral data into interpretable rules, which server then encodes back into structured features. This loop constitutes a non-conventional use of the generative AI model and yields improved learning efficiency: fewer labeled examples are required to obtain well-calibrated models because the generative AI model infers cross-context patterns that would otherwise demand manual feature engineering. Because these processes are implemented as specific data flows, model architectures, loss functions, optimization routines, and prompt construction schemes operating on defined hardware (CPU, GPU, storage, network, camera, microphone, position sensor, display, and input devices), the system as a whole goes beyond a mere abstract idea or business method. The claimed embodiments provide concrete improvements to the functioning of computing devices in the domains of multimodal state estimation, language-based candidate generation, interactive ranking, and adaptive interface control.

### I. Variations and Alternative Embodiments

Server may implement different neural network architectures. For example, server may use transformer-based encoders for multimodal fusion instead of simple concatenation; server may employ attention mechanisms that weight particular modalities more heavily depending on context. Server may implement the ranking model as a gradient-boosted decision tree model instead of a neural network, where the extracted features (including features derived from generative AI analysis) form input variables.

Terminal may perform part of the emotion estimation or context evaluation locally, such as computing a preliminary stress index from selection latency and simple facial metrics, and send reduced feature vectors to server, thereby reducing network bandwidth. In another embodiment, terminal may execute a lightweight generative model fine-tuned for specific phrase domains and cache frequently selected candidate sets for offline usage.

Server may employ different forms of prompt sentences. For example, server may include more detailed instructions such as:

“Ensure that the utterance candidates are polite and short because the user is currently in a high-stress state in a medical facility waiting room.”

or may explicitly forbid certain categories of expressions. These modifications are realized through changes in prompt text while preserving the same overall construction steps. Server may adjust learning schedules and data augmentation techniques. For instance, server may perform oversampling of feedback records from rare but critical contexts (such as emergency situations), or may artificially augment conversation contexts by injecting paraphrased utterance histories produced by the generative AI model itself. Server may use regularization strategies such as dropout in the neural networks to prevent overfitting and improve generalization.

By allowing such variations while maintaining the core structure-multimodal context and emotion estimation, user-model-driven prompt sentence construction, generative AI model based candidate generation, ranking and presentation mode control, and structured feedback-driven model update—the embodiments collectively support the scope of the claims and enable a person skilled in the art to implement the invention on various computing platforms.

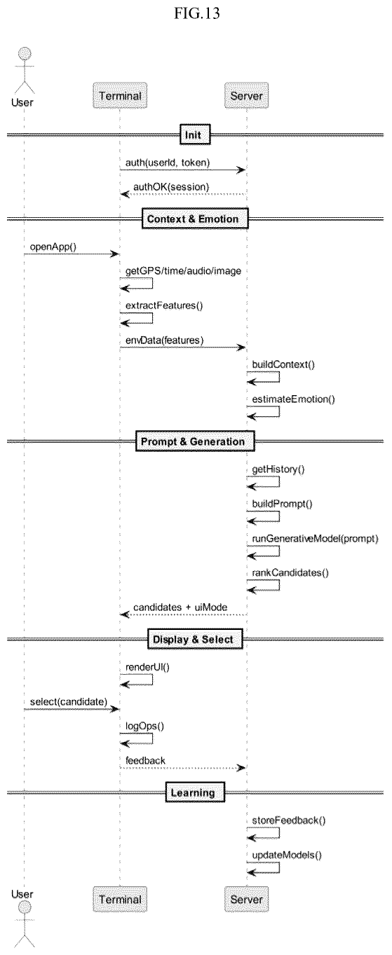

The following describes the processing flow using FIG. 13.

### Step 1:

Server initializes models and data connections.

Server takes, as input, parameter files of a generative AI model, parameter files of an emotional state estimation model, and configuration information for a relational database. Server uses a deep learning library to deserialize the model parameters from storage, uploads weight tensors to a matrix computation device, and performs a warm-up forward pass to ensure that kernels and memory allocations are ready. Server also uses a database driver to establish pooled connections to tables for users, conversation histories, emotion histories, contexts, and feedback. Server outputs initialized in-memory models and active database connections that are ready for subsequent inference and learning operations.

### Step 2:

Terminal establishes a session and identifies the user.

Terminal takes, as input, locally stored user identification data and authentication credentials. Terminal composes an authentication request message and transmits it to server via a secure communication protocol. Terminal performs basic data formatting, such as constructing a structured message with user ID and token. Server receives this message, executes a lookup and comparison against stored credentials in the user table, and returns a response indicating success and containing a user model identifier. Terminal outputs a session state including the authenticated user ID and associated user model identifier for later use.

### Step 3:

Terminal acquires raw sensor data for context.

Terminal takes, as input, no external data but triggers hardware access when the user opens a communication support screen. Terminal queries a position sensor to obtain latitude and longitude, queries the operating system clock to obtain the current time and date, activates a microphone to record environmental sound for a defined period, and activates a camera to capture at least one image including the user's face. Terminal outputs raw data including position coordinates, a timestamp, a raw audio buffer, and an image frame.

### Step 4:

Terminal extracts feature quantities from raw sensor data.

Terminal takes, as input, the raw position coordinates, timestamp, audio buffer, and image frame. Terminal converts coordinates to a standardized numeric format, converts the timestamp into an ISO-like representation, and uses an image processing library to detect a face region and facial landmarks from the image. Terminal uses an audio analysis library to compute acoustic features such as energy, noise level, and spectral characteristics from the recorded sound. Terminal also initializes operation log state variables (screen opening time, initial tap count, initial scroll amount). Terminal performs data processing by aggregating these items into a structured environment packet and outputs a packet containing position information, time information, facial feature quantities, acoustic feature quantities, and initial operation log information.

### Step 5:

Terminal transmits environment information and initial logs to server.

Terminal takes, as input, the environment packet produced in Step 4. Terminal serializes the packet into a structured message, applies any necessary compression or encoding, and sends the message to server over the network. Terminal outputs the transmitted data on the communication interface and updates its internal state to indicate that it is waiting for candidate information from server.

### Step 6:

Server derives context information from environment data.

Server takes, as input, the environment packet including position information, time information, and acoustic feature quantities. Server parses the message, then uses a geographic information resource to map latitude and longitude to a place type, uses time thresholds to categorize the timestamp into a time-of-day label, and applies thresholding or clustering to acoustic feature quantities to derive an environment label such as “quiet,” “medium noise,” or “loud noise.” Server then encodes these labels into categorical embeddings or codes, combines them with numeric features such as approximate decibel level, and constructs a context record. Server outputs both a symbolic context description (place type, time-of-day, environment label) and a numeric context vector for later processing.

### Step 7:

Server estimates the current emotional state using multimodal features.

Server takes, as input, facial feature quantities, acoustic feature quantities, and initial operation log information from the environment packet, and retrieves recent emotion history for the user from the database if available. Server converts feature quantities into tensors suitable for the emotional state estimation model. Server performs data computation by running a forward pass through the multimodal neural network: individual sub-networks process visual, audio, and behavioral features, and their outputs are fused and passed to classification and regression heads. Server outputs an emotional state consisting of an emotion category and a stress level, and stores this state in the emotion history table with an associated timestamp and context identifier.

### Step 8:

Server generates a textual description of context and emotional state.

Server takes, as input, the symbolic context labels and the emotional state determined in previous steps. Server applies string templates or formatting routines to convert symbolic values into natural language sentences, such as “The user is now in a café in the morning with a medium level of background noise.” and “The user is relaxed and has low stress.” Server outputs a context description text and an emotional state description text to be embedded into a prompt sentence.

### Step 9:

Server retrieves conversation history and formats a dialogue log.

Server takes, as input, the user identifier from the authenticated session state. Server queries the conversation history table for records associated with that user, orders them by timestamp, and selects a limited number of recent utterances. Server performs data processing by converting each record into a labeled text line indicating whether the speaker is the user or a communication partner and concatenates the lines into a single dialogue log text. Server outputs the dialogue log text that summarizes recent interactions.

### Step 10:

Server constructs a prompt sentence for the generative AI model.

Server takes, as input, the dialogue log text, the context description text, and the emotional state description text. Server inserts these texts into a predefined template that also includes instructions on the role of the generative AI model and the required output format. Server performs string concatenation and variable substitution to generate a complete prompt sentence. Server outputs a prompt sentence that includes conversation history, context information, emotional state, and explicit instructions to generate a list of conversation candidates.

### Step 11:

Server invokes the generative AI model to produce conversation candidates.

Server takes, as input, the prompt sentence constructed in Step 10. Server uses a natural language processing library to tokenize the prompt sentence into a sequence of model-specific tokens and sends this sequence to the generative AI model running on the matrix computation device. Server performs data computation by iteratively applying transformer layers with self-attention and feed-forward operations to predict successive output tokens according to configured decoding parameters. Server then converts the resulting output tokens back into text, parses the text into separate candidate lines, and assigns each candidate a unique identifier. Server outputs a list of conversation candidate texts and their identifiers.

### Step 12:

Server scores conversation candidates and selects a presentation mode.

Server takes, as input, the list of candidate texts and identifiers, together with the context vector, emotional state vector, user model parameters, and historical selection information from the feedback table. Server embeds candidate texts into vectors and concatenates them with context and emotional features. Server uses the ranking model to compute a score for each candidate and optionally applies additional rules using historical selection frequencies. Server orders candidates by their scores and evaluates the current stress level to decide how many candidates to present and which display format to use. Server then packages the ranked candidates and presentation parameters, such as number of candidates, font size, and emphasis markers, into a presentation message. Server outputs a structured message containing candidate texts, scores, ranking order, and display mode information.

### Step 13:

Terminal receives candidate data and renders the user interface.

Terminal takes, as input, the presentation message from server. Terminal parses the candidate list, their scores, and presentation parameters. Terminal performs data processing by mapping presentation parameters to user interface layout properties, such as card size, font size, button spacing, and visible item count. Terminal then renders display elements on the screen using the graphics subsystem, placing each candidate text in a selectable region consistent with the specified layout. Terminal outputs a visual interface showing the conversation candidates ready for user interaction.

### Step 14:

User selects a conversation candidate through an input modality.

User takes, as input, the visual presentation of candidates displayed on terminal. User visually inspects the options and then performs a concrete action such as tapping a candidate card on the touch screen, directing gaze to a specific candidate for a certain time, or issuing a voice command specifying a candidate. User outputs an interaction signal, such as a tap, a gaze fixation, or a spoken phrase, to terminal's input devices.

### Step 15:

Terminal detects the user's selection and optionally outputs speech.

Terminal takes, as input, signals from its input devices, such as touch events, gaze coordinates from a gaze tracker, and recognized speech commands from a speech recognizer. Terminal maps these signals to a particular candidate identifier by determining which screen region was interacted with or which candidate number was spoken. Terminal updates the user interface to highlight the selected candidate. If a speech output mode is active, terminal forwards the selected candidate text to a text-to-speech component, which synthesizes audio and plays it through a speaker. Terminal outputs the selected candidate identifier, selected text, selection timestamp, and updated operation log metrics, including elapsed time since display, tap count, and scroll distance.

### Step 16:

Terminal constructs feedback data and transmits it to server.

Terminal takes, as input, the selected candidate identifier and text, the selection timestamp, the initial display timestamp, and accumulated operation log information. Terminal computes, as data processing, the elapsed time from candidate presentation to selection, summarizes the number of operations and screen scroll amount, and packs these values into a structured feedback record along with the candidate identifier and text. Terminal then transmits the feedback record to server via the communication interface. Terminal outputs a sent feedback message and resets or updates internal log counters for subsequent interactions.

### Step 17:

Server stores feedback data and associates it with context and emotional state.

Server takes, as input, the feedback record received from terminal. Server queries the context store and emotion history table for records close in time to the selection timestamp, and retrieves the relevant context labels and emotional state at the time of selection. Server combines these elements with the feedback record to form a complete feedback entry containing selection behavior, context, and emotion. Server performs a database insertion operation to store this entry in the feedback table. Server outputs an updated feedback table record that can be used for future training and analysis.

### Step 18:

Server updates models based on accumulated feedback.

Server takes, as input, a batch of feedback entries, corresponding conversation history snippets, context vectors, and emotional state vectors. Server constructs training datasets by mapping each feedback entry to numerical feature vectors and labels indicating selected versus non-selected candidates. Server performs data computation by feeding these batches through the user model and ranking model networks, computing loss values, and applying backpropagation and optimization to adjust model parameters on the matrix computation device. Server also updates the emotional state estimation model using labeled emotional state data. Server outputs updated parameter sets for the user model, ranking model, and emotional state estimation model, resulting in modified inference behavior that reflects the user's observed selection patterns.

### Step 19:

Server performs meta-level analysis of feedback using the generative AI model.

Server takes, as input, multiple summarized feedback entries along with their context and emotional state descriptions. Server composes a meta-level prompt sentence that includes an instruction to describe preference tendencies and appends the summarized data as examples. Server tokenizes this prompt and executes the generative AI model to generate a natural language description of patterns, such as tendencies regarding politeness, sentence length, or emotional polarity under different emotional states. Server then parses the output text to extract structured features, such as weights indicating preference for short phrases under high stress. Server updates internal configuration so that these features are included as inputs to the ranking model or as modifications to user model parameters. Server outputs refined feature sets that improve the interpretability and performance of subsequent ranking operations.

### Step 20:

User continues interaction and system iteratively improves.

User takes, as input, new sets of conversation candidates generated after model updates in subsequent cycles. User selects candidates in various contexts, providing additional interaction data. Terminal collects and transmits new environment packets and feedback records. Server repeatedly applies the above steps, using accumulated data to refine models and prompt sentence constructions. Server outputs progressively more accurate candidate sets and more appropriate presentation modes, thereby reducing average selection time, improving prediction accuracy, and lowering the computational and communication burden per successful interaction over time.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional care-support systems that run on general-purpose computer hardware typically process physiological data, activity logs, and limited context information using fixed, rule-based logic or static machine-learning models. Such systems suffer from several technical problems from the standpoint of computer technology.

First, known systems generally treat multimodal inputs-biological information from sensors, environmental information, and emotion-related cues from images and audio—as independent data streams processed in isolated pipelines. This leads to fragmented data representations and inhibits the computer from constructing a unified, machine-interpretable state that accurately reflects a user's health state, context, and emotional state at a given time. As a result, prediction accuracy for subsequent care actions is limited, and the system's overall computational resources are not efficiently directed toward the most relevant care hypotheses. Second, when generative artificial-intelligence models are used, existing systems typically pass ad-hoc or manually crafted instructions to such models. These instructions are not systematically derived from the underlying numerical state held by the computer. Consequently, the prompts supplied to the generative artificial-intelligence models do not fully exploit the machine-readable features stored in memory, such as feature vectors computed from physiological signals, context indicators, and emotion vectors. This mismatch between internal data representations (vectors, time-series structures) and external natural-language prompts reduces the quality and consistency of the generative output, requiring human operators to perform additional interpretive work and limiting automation.

Third, conventional feedback mechanisms for care decisions are not tightly integrated into the computational models. While some systems log outcomes, they often fail to convert pre- and post-care multimodal data into structured effect indicators that can be fed back into the prediction models. In particular, prior systems lack a mechanism in which the computer autonomously summarizes care-effect logs into machine-readable and human-readable forms, constructs structured prompt sentences for a generative artificial-intelligence model, and then uses the model's output (for example, rules or policies) to algorithmically adjust internal parameters such as loss-function weights, reward definitions, and decision thresholds. This results in a static or slowly adapting model that does not fully benefit from accumulated care-execution data and does not improve its inference process at the same rate as new data becomes available.

Fourth, there is no established architecture in which the computer's internal state vector-integrating health-state feature vectors, context feature vectors, and emotion vectors—is programmatically transformed into a human-readable explanation and instruction-rich prompt sentence, sent to a generative artificial-intelligence model, and then parsed back into structured care candidates. In prior implementations, the conversion between numeric feature space and natural-language space is either manual, heuristic, or non-systematic. This prevents the system from operating as a coherent pipeline where each stage-data acquisition, feature extraction, integrated state construction, prompt generation, generative inference, and feedback learning—is optimized as part of a unified computer-implemented process. Accordingly, there is a need for a computer-implemented system that improves the way a processor acquires and integrates multimodal care-related data, converts its internal numerical state into optimized prompt sentences for a generative artificial-intelligence model, parses the generative output back into structured care candidates, and uses objective and subjective feedback to automatically refine its prediction model. Such a system would represent an improvement in computer technology by enabling more accurate, efficient, and adaptive care-candidate generation based on complex, high-dimensional input data and by tightly coupling generative artificial-intelligence inference with the underlying machine-learning models executed by the processor.

The specific processing by the specific processing unit 290 of the data processing device 12 in Application Example 2 is realized by the following means.

The present invention provides a server comprising a processor and a memory storing instructions that, when executed by the processor, cause the processor to acquire, from one or more sensor devices via a communication interface, biological information, life-history information, and behavior-history information related to a care target, to model, based on the biological information, the life-history information, the behavior-history information, and care execution results, a health state and a behavior pattern for each care target as a learned model, to acquire, via a communication network, position information and environment information related to the care target, to generate context information characterizing a current situation of the care target based on the position information, the environment information, and an activity-amount indicator, to estimate an emotional state of the care target by executing a facial-expression analysis process and a speech-analysis process based on image information, audio information, and the biological information and to calculate an emotion vector including, as elements, an anxiety degree, a pain degree, a depression degree, and a calmness degree, to generate a state vector by integrating a health-state feature vector obtained from the learned model, a context feature vector obtained from the context information, and the emotion vector and to estimate or generate, based on the state vector, a plurality of care candidates to be performed for the care target, to perform data processing that converts the state vector into a human-readable explanatory text, to construct a prompt sentence including the explanatory text and an instruction sentence that specifies at least one of a number of care candidates, an output format, and an output language, and to transmit the prompt sentence to a generative artificial-intelligence model, to receive, from the generative artificial-intelligence model, a natural-language text output in response to the prompt sentence, to extract, from the natural-language text, at least a care name, a care purpose, a care priority, and a care procedure, to organize the extracted information as structured data, and to generate, as display data, the plurality of care candidates represented by the structured data, to cause a terminal apparatus to present, via a display device and/or an audio output device of the terminal apparatus, the plurality of care candidates included in the display data and an attention message corresponding to the emotion vector to a caregiver, to receive, from the terminal apparatus, a selection result indicating at least one care candidate selected from among the plurality of care candidates in accordance with an operation through an input device of the terminal apparatus, and to record the selection result in association with a care target identifier, to acquire, based on a start time and a completion time of a selected care indicated by the selection result, the biological information and the emotion vector in respective time windows before and after the selected care, to calculate a care-effect indicator based on differences between pre-care values and post-care values of the biological information and the emotion vector, to record the care-effect indicator as an evaluation vector, and to store, as learning data, the evaluation vector in association with subjective evaluation information input by the caregiver, and to reflect the learning data in estimation or generation of the care candidates by updating parameters of a prediction model, and to convert the learning data or summary information thereof into a natural-language explanatory text, to construct a further prompt sentence including the explanatory text and an instruction sentence requesting extraction of characteristics of care having a high care effect and requesting a proposal of a model-update policy, to transmit the further prompt sentence to the generative artificial-intelligence model, to receive, from the generative artificial-intelligence model, at least one rule or update policy output in response to the further prompt sentence, and to adjust parameters of the prediction model based on the at least one rule or update policy. This enables an improved computer-implemented care-support process in which multimodal sensor data are integrated into a unified state vector, the unified state is systematically transformed into optimized prompt sentences for a generative artificial-intelligence model, the generative output is converted back into structured care candidates, and objective and subjective feedback are automatically used to refine the underlying prediction model, thereby enhancing the accuracy, adaptability, and computational efficiency of care-candidate generation.

The term “biological information” refers to measurement data representing a physiological state of a care target, including at least one of heart rate, blood pressure, body temperature, blood oxygen saturation, respiration rate, body movement, and other vital-sign indicators acquired from a sensor device.

The term “life-history information” refers to time-series information related to daily living activities of a care target, including at least one of medication history, meal records, sleep patterns, exercise records, and records of activities of daily living.

The term “behavior-history information” refers to recorded information describing behavior of a care target, including at least one of movement history, room-usage history, change in activity amount, and history of care executions.

The term “care target” refers to a human subject who is a recipient of care services and for whom biological information, life-history information, behavior-history information, image information, and audio information are acquired.

The term “sensor device” refers to an electronic device configured to acquire biological information, environment information, position information, or other physical measurements, and includes at least one of a wearable device, a bed sensor, a room sensor, and a positioning device.

The term “health state” refers to an internal representation of a physical condition of a care target that is modeled by a computer based on biological information, life-history information, behavior-history information, and care execution results.

The term “behavior pattern” refers to a statistical or learned representation of recurring behavior tendencies of a care target, derived from behavior-history information and optionally correlated with care execution results.

The term “learned model” refers to a parameterized computational model implemented by a processor, whose parameters are obtained by a machine-learning process using biological information, life-history information, behavior-history information, and care execution results as training data.

The term “position information” refers to information indicating a location of a care target, including at least one of coordinate information, room identifiers, and zone identifiers acquired from a positioning device or a communication device.

The term “environment information” refers to information indicating a surrounding environment of a care target, including at least one of sound-pressure level, noise category, illuminance, temperature, humidity, and operation status of equipment.

The term “activity-amount indicator” refers to a quantitative indicator representing a magnitude of physical activity of a care target, including at least one of step count, body-movement count, and posture-change frequency.

The term “context information” refers to higher-order state information that characterizes a current situation of a care target by integrating position information, environment information, activity-amount indicators, and optionally other surrounding-situation information.

The term “image information” refers to digital image data acquired by an imaging device, including at least one of still images and video frames depicting a face, body, or surroundings of a care target.

The term “audio information” refers to digital audio data acquired by a sound-collection device, including at least one of speech of a care target, vocalizations such as groans, breathing sounds, and surrounding environmental sounds.

The term “emotional state” refers to a psychological or affective state of a care target, represented by numerical or categorical indicators for emotions such as anxiety, pain, depression, calmness, and excitement.

The term “emotion vector” refers to a multi-dimensional vector representation of an emotional state, having components that respectively indicate at least an anxiety degree, a pain degree, a depression degree, and a calmness degree.

The term “facial-expression analysis process” refers to a computation executed by a processor that detects a face region from image information, extracts facial features, and outputs emotion-related indicators or scores based on the facial features.

The term “speech-analysis process” refers to a computation executed by a processor that extracts acoustic features from audio information and outputs emotion-related indicators or scores based on the acoustic features.

The term “health-state feature vector” refers to a vector-type data structure comprising statistical or learned features derived from biological information, life-history information, behavior-history information, and care execution results, and representing a health state of a care target.

The term “context feature vector” refers to a vector-type data structure comprising features derived from context information, including at least one of encoded position information, environment category, and activity-amount indicators.

The term “state vector” refers to an integrated vector-type data structure obtained by combining at least a health-state feature vector, a context feature vector, and an emotion vector, and representing a unified internal state of a care target at a given time.

The term “care candidate” refers to an option of care action that can be performed for a care target, including at least one of physical care, psychological care, environmental adjustment, and communication support, and that is generated or estimated by a processor.

The term “prompt sentence” refers to a natural-language or structured-text instruction provided to a generative artificial-intelligence model, the instruction including at least a human-readable explanatory text about a state vector and an instruction sentence specifying a desired output condition such as a number of care candidates, an output format, or an output language.

The term “explanatory text” refers to a human-readable description generated by a processor by converting numerical elements of a state vector into qualitative expressions based on comparison with reference values or rules.

The term “instruction sentence” refers to a portion of a prompt sentence that specifies conditions or constraints for an output of a generative artificial-intelligence model, including at least one of an output type, an output format, an output language, and a required number of items.

The term “generative artificial-intelligence model” refers to a machine-learning model trained on a large dataset and configured to generate text, numerical values, or structured data in response to an input prompt sentence.

The term “structured data” refers to data organized into predefined fields, records, or key-value pairs that represent machine-interpretable attributes of a care candidate, including at least a care name, a care purpose, a care priority, and a care procedure.

The term “display data” refers to data derived from structured data that is formatted for presentation on a user interface of a terminal apparatus, including at least textual elements and optionally visual or audio elements.

The term “attention message” refers to a message generated by a processor based on an emotion vector and configured to inform a caregiver of precautions or recommended interaction styles when performing a care candidate.

The term “terminal apparatus” refers to an information-processing apparatus used by a caregiver, equipped with at least a display device and an input device, and configured to present care candidates and accept selection operations.

The term “selection result” refers to information indicating at least one care candidate chosen by a caregiver from among a plurality of care candidates presented on a terminal apparatus, and including at least a care candidate identifier and a selection time.

The term “care-effect indicator” refers to a quantitative indicator representing an effect of executed care, calculated based on differences between pre-care values and post-care values of at least one of biological information and an emotion vector.

The term “evaluation vector” refers to a vector-type data structure that stores one or more care-effect indicators and optionally additional evaluation values associated with a particular care execution.

The term “subjective evaluation information” refers to evaluation data input by a caregiver that qualitatively assesses effectiveness of executed care, including at least one of categorical ratings and free-form comments.

The term “learning data” refers to data stored in association with a care target and including at least one of evaluation vectors, subjective evaluation information, and corresponding state vectors, used to train or update a prediction model.

The term “prediction model” refers to a machine-learning model executed by a processor for estimating or generating care candidates based on at least a state vector and optionally learning data.

The term “model-update policy” refers to information indicating how at least one parameter, structure, or hyperparameter of a prediction model should be changed, including at least one of feature-weighting rules, threshold-adjustment strategies, and reward-design policies.

The term “rule” refers to a machine-interpretable condition or mapping that specifies a relationship between at least one input condition derived from a state vector or learning data and at least one model parameter, decision threshold, or output behavior.

The term “care-execution log” refers to a record that includes at least a state vector before care, performed care content, time information, a care-effect indicator, and subjective evaluation information corresponding to a particular care execution.

The term “loss function” refers to a mathematical function used during training of a prediction model to quantify a difference between a predicted output and a target output and to guide parameter updates.

The term “reward design” refers to a definition of numerical rewards assigned to outcomes or actions in a learning framework, configured so that the prediction model increases the expected reward by favoring more effective care candidates.

The term “decision threshold” refers to a numerical threshold used by a prediction model or classifier to determine an output decision, such as whether to propose or prioritize a particular care candidate.

The term “server” refers to an information-processing apparatus comprising at least one processor, a memory, and a communication interface, and configured to execute at least one of data acquisition, feature extraction, state-vector generation, prompt-sentence generation, generative-model interaction, care-candidate estimation, and feedback learning.

In one embodiment, a server, one or more terminals, and one or more sensor devices cooperate to implement the claimed system. The server is an information processing apparatus including at least one processor, a main memory, a non-volatile storage device, and a communication interface. The server executes a general-purpose operating system such as a server-class UNIX-like operating system. On top of the operating system, the server executes application software including a web application framework (for example, a script-language-based web framework), a database management system (for example, a relational database engine), a numerical computation library (for example, a matrix and vector computation library), a machine-learning framework (for example, a tensor-operation-based deep-learning library), and a generative AI model runtime.

The terminal is a portable or stationary information processing apparatus used by a caregiver. The terminal includes at least a display device, an input device such as a touch panel, a microphone, a camera, a speaker, a short-range wireless interface, and a wide-area wireless interface. The terminal executes a mobile or desktop operating system, and a client application specific to this system runs on the operating system. The terminal is configured to communicate with the server via a network such as a local wireless network, a cellular network, or a wired network.

The user is a care target, typically an elderly person or a person with communication difficulty. The user wears at least one wearable sensor device configured to measure biological information such as heart rate, blood pressure, body temperature, and blood oxygen saturation. The user may lie on a bed equipped with a bed sensor configured to measure body movement and sleep state. The user stays in an environment where environmental sensors such as microphones, cameras, and beacon devices are installed.

The server executes a program that implements multiple functional modules corresponding to the learning means, context acquisition means, emotion acquisition means, prompt generation means, prediction means, generation-result analysis means, feedback means, and model-update support means described in the claims. Each module is realized as a software component executed by the processor and cooperating through explicitly defined data structures stored in the memory and the database.

The server stores, in a database, multiple tables including, for example, a raw sensor table, a health-state feature table, a context feature table, an emotion-state table, a user-state table, a care-candidate table, a care-selection table, a care-effect table, and a care-feedback table. Each table is defined with explicit fields and indices so that the processor can efficiently retrieve and update records. For instance, the health-state feature table includes fields such as a user identifier, a time window identifier, and a serialized health-state feature vector. The emotion-state table includes fields such as a user identifier, a timestamp, and an emotion vector comprising an anxiety component, a pain component, a depression component, and a calmness component.

The server uses a numerical computation library to perform data processing operations such as time-series resampling, filtering, normalization, and feature extraction. For example, when the server receives raw heart rate measurements from the terminal, the server stores the raw values into the raw sensor table, and later applies a moving average filter and outlier rejection algorithm to the raw time series. The server then aggregates the cleaned data in fixed time windows and computes statistical features such as mean heart rate, variance of heart rate, maximum systolic blood pressure, minimum diastolic blood pressure, and a sleep fragmentation index based on bed-movement counts. The server packs these features into a fixed-length health-state feature vector and stores the vector as a binary or serialized object in the health-state feature table.

The server uses the machine-learning framework to construct and train a learned model that represents the health state and behavior pattern of each user. In one embodiment, the server constructs a recurrent neural network or a model with a self-attention mechanism to process sequences of health-state feature vectors and care execution events. The server defines an input layer that receives a sequence of feature vectors, one or more hidden layers such as gated recurrent units or transformer blocks, and an output layer that predicts, for each time step, a distribution over care action types or an expected care effect. The server defines a loss function such as a cross-entropy loss for care-type prediction or a mean-squared error loss for predicted effect values. The server trains the model by repeatedly loading batches of historical sequences from the database, performing forward propagation to obtain predictions, computing the loss, and then performing backpropagation and parameter updates using an optimizer such as stochastic gradient descent or Adam. The server may apply regularization techniques such as dropout, early stopping, or weight decay to improve generalization. The server performs facial-expression analysis by applying a convolutional neural network to face images stored in the media repository. The server uses an image-processing library to read a face image, resize the image to a fixed resolution, normalize pixel values, and arrange the image into a tensor. The server forwards the tensor to a deep neural network with multiple convolutional layers, activation functions such as rectified linear units, pooling layers, and fully connected layers. The output layer of this model produces probabilities over a fixed set of basic facial emotion categories. The server computes a first emotion score by combining the categorical probabilities into continuous indicators, for example by defining the anxiety indicator as a weighted sum of the fear and sadness probabilities. The server writes the resulting scores to the emotion-state table in association with the corresponding timestamp and user identifier.

The server performs speech-based emotion analysis by applying a time-series model to acoustic features extracted from audio data. The server uses an audio library to compute Mel-frequency cepstral coefficients or spectrogram features for each audio clip. The server stacks these feature vectors into a two-dimensional or three-dimensional tensor representing the evolution of acoustic features over time. The server then forwards the tensor through a neural network such as a bidirectional recurrent network or a transformer encoder that accepts sequence input. The output is a set of probabilities for voice-based emotion categories such as calm, anxious, or possible pain complaint. The server defines a second emotion score by mapping the category probabilities to continuous indicators such as a voice-based anxiety score and a voice-based pain score.

The server combines the facial-expression scores, speech-based scores, and time-aligned vital features into a multimodal feature vector. The server then applies a multimodal emotion estimation model that uses an attention mechanism to fuse modalities. In one example, the server constructs a model with modality-specific encoders for facial features, audio features, and vital features, and an attention-based fusion layer that computes attention weights over modalities for each target emotion dimension. The model outputs an emotion vector comprising an anxiety degree, a pain degree, a depression degree, and a calmness degree. By using attention-based fusion, the server enables the model to selectively up-weight more reliable modalities (for example, vital signs when audio is noisy) and thereby increases robustness and accuracy of emotion estimation compared to simple concatenation or manual rules.

The server constructs context information by combining position information, environment information, and activity-amount indicators. The server stores room labels, location identifiers, noise level categories, and activity levels in the context feature table. The server encodes these attributes into a numerical context feature vector, for example by one-hot encoding of categorical values and normalization of continuous values. The server then constructs a unified state vector by concatenating the health-state feature vector, the context feature vector, and the emotion vector. The server may further apply dimensionality reduction or normalization to the state vector so that subsequent models operate on a numerically stable input domain.

The server converts the state vector into a human-readable explanatory text. To do so, the server implements a rule-based mapping that transforms numeric values into qualitative expressions. For example, the server retrieves a baseline heart rate for a user from the database and computes a deviation of the current mean heart rate from the baseline. If the deviation exceeds a first threshold but is below a second threshold, the server generates a phrase such as “slightly higher than usual heart rate.” If the noise level is classified as “noisy,” the server generates a phrase such as “the environment is rather noisy with background sounds.” If the anxiety component of the emotion vector exceeds a high threshold, the server generates a phrase such as “the user appears quite anxious.” The server concatenates these phrases into sentences using template-based text generation, forming an explanatory text that accurately reflects the numerical state stored in the computer.

The server constructs a prompt sentence by combining the explanatory text with an instruction sentence that specifies desired output conditions for the generative AI model. In one embodiment, the server constructs a prompt sentence as follows:

“Based on the following user state, please propose three care candidates to perform next.
Health status: heart rate 90 bpm (slightly higher than usual), blood pressure 135/80, last night's sleep 4.5 hours with frequent awakenings.
Context: currently in the living room watching television. The environment is slightly noisy.
Emotional state: anxiety 0.7 (high), pain 0.2 (low), depression 0.4 (moderate).

The user is an elderly person with a language impairment who cannot explain their condition well.

Consider both physical and psychological care, and output three care candidates in Japanese, ordered by priority, with concise explanations.”

In another embodiment, the server constructs a prompt sentence for model update as follows: “Below are summarized logs including users' health states, context information, emotion states, care performed, and the objective and subjective effects. Please identify patterns of care that show high anxiety-reduction effect and propose rules or model-update policies so that such care is prioritized in future care-candidate generation.”

The server transmits the constructed prompt sentence to a generative AI model. The generative AI model may be hosted on the same server hardware, on a separate server, or as a cloud-based service. The server passes the prompt sentence through an application programming interface, and receives a textual response that includes descriptions of care candidates or rules and policies. By automatically generating prompt sentences from the internal state vector, the server ensures a consistent and comprehensive use of the machine-readable data when invoking the generative AI model.

The server parses the textual response from the generative AI model. The server uses deterministic parsing rules or lightweight natural-language parsing to extract structured fields such as care names, care purposes, care priorities, and care procedures. For example, when the response includes numbered items, the server identifies item boundaries, locates key phrases such as “purpose” or “step,” and maps the phrases to fields in a care-candidate data structure. The server stores the resulting structured data in the care-candidate table and generates display data that can be rendered by the terminal.

The terminal receives the display data and renders a graphical interface. The terminal displays each care candidate as a card containing a name, a short description, a priority level, and an estimated time. If the server has generated an attention message based on the emotion vector (for example, instructions to speak slowly and to avoid sudden movements), the terminal displays the attention message prominently. The terminal may also invoke a text-to-speech library to read aloud the care descriptions so that the caregiver can receive information without constantly viewing the display.

The terminal receives a selection input from the caregiver. When the caregiver taps a card, the terminal records the selection with a timestamp and transmits a selection result to the server. The server records the selection in the care-selection table and associates it with the corresponding user state. The server may also send detailed procedural guidance for the selected care back to the terminal, such as sequenced steps and further warnings, which the terminal displays.

The server later receives start and completion events for the selected care from the terminal. Using these timestamps, the server queries the emotion-state table and the health-state feature table to retrieve pre-care and post-care data in defined time windows. The server computes differences between pre-care and post-care quantities, such as a change in the anxiety component of the emotion vector, a change in heart rate, and a change in pain level. The server packs these differences into an evaluation vector and stores the vector in the care-effect table. The server further receives subjective evaluation information from the terminal, such as categorical ratings (for example, “very effective”) and free-text comments, and stores these data in the care-feedback table linked to the evaluation vector.

The server uses the evaluation vectors and subjective evaluation information as learning data to update the prediction model. The server defines an auxiliary loss function that penalizes discrepancies between predicted and observed care effects, and adjusts feature weights so that care candidates that historically yielded higher improvements in emotional and physiological indicators are more strongly preferred in future predictions. The server may re-train the prediction model periodically using the care-execution logs, or perform online updates, depending on system configuration.

The server also uses the learning data to construct prompt sentences for the generative AI model dedicated to model update support. The server summarizes multiple care-execution logs into a natural-language explanatory text, for example describing that certain types of care (such as moving to a quieter room combined with reassuring speech) tend to produce larger reductions in anxiety under high-noise conditions. The server embeds this summary into a prompt sentence that explicitly requests feature-weighting rules or threshold adjustment policies from the generative AI model. The server receives a response describing, for example, that environmental adjustment should be prioritized when the noise level is high and the anxiety component exceeds a threshold. The server converts such textual rules into machine-interpretable rules or numeric adjustments, such as increasing the weight of noise level and anxiety components in the state vector, or lowering the decision threshold for suggesting environmental adjustments.

By coupling the prediction model with the generative AI model in this manner, the server achieves a technical effect of automatically tuning complex model parameters and decision rules based on a large volume of feedback data, in a way that would be difficult or impractical for human operators to design manually. This interaction is not a mere automation of human reasoning, because the server operates in the vector space of internal numerical representations and uses algorithmic mappings between vectors and prompt sentences to efficiently expose high-dimensional patterns to the generative AI model.

The system provides several technical advantages. Because the server integrates multimodal inputs into a single state vector and uses attention-based multimodal fusion, the emotion estimation is more accurate and robust than simple rule-based fusion, which in turn improves the quality of care-candidate predictions. Because the server automatically generates prompt sentences that comprehensively reflect numerical internal states, the communication between the prediction pipeline and the generative AI model is standardized and optimized, reducing the need for human-specified prompts and lowering the risk of omission of relevant features. Because the server converts the output of the generative AI model into structured data and feeds back objective and subjective evaluation data into the prediction model, the system realizes a closed-loop learning architecture that continuously improves the model's performance.

Furthermore, the system improves the efficiency of data management and computation. The server defines explicit feature vectors and normalized data structures that allow batch processing and caching, thereby reducing redundant computation when new care candidates are generated. The server can cache state vectors and reuse them when the state has not changed significantly, reducing the frequency of full recomputation and lowering the computational load. The system also reduces communication load by sending compressed images and audio clips at adaptive intervals determined by activity level or event triggers, instead of transmitting high-rate raw data continuously.

The use of neural network architectures, such as recurrent networks for temporal modeling, convolutional networks for visual feature extraction, and transformer-based models for multimodal fusion, is described with explicit structures, loss functions, and update procedures. The server defines feature sets, training objectives, and optimization algorithms. These details show that the invention is directed to a particular improvement in computer-implemented data processing and model-training workflows, rather than to an abstract idea. The system processes raw sensor data from real-world environments, controls the content and timing of information presented to caregivers on terminals, and uses learned models to influence physical actions performed by caregivers, such as moving a user to another room or adjusting environmental equipment. Thus, the system is tied to a particular machine configuration and yields concrete technical effects, including improved accuracy and responsiveness of care suggestion, more efficient use of computational and network resources, and enhanced stability and adaptability of the underlying prediction models.

Alternative embodiments are possible. The server may replace the recurrent prediction model with a purely attention-based temporal model, or may use different loss functions such as ranking losses when optimizing the order of care candidates. The emotion-fusion model may use other fusion techniques such as gated multimodal units. The prompt generation rules may be extended to include additional constraints, such as resource availability or staff workload. The generative AI model may be a general-purpose language model or a domain-adapted model fine-tuned on care-related corpora. The terminal may be a head-mounted display or a voice-controlled device, as long as it includes a display or audio output and an input mechanism. In each case, the core architecture-integrating multimodal sensor data into a state vector, mapping the state vector to a prompt sentence, invoking a generative AI model, converting the output to structured care candidates, and closing the loop with feedback learning-remains substantially the same and provides the described improvements in computer-implemented care-support processing.

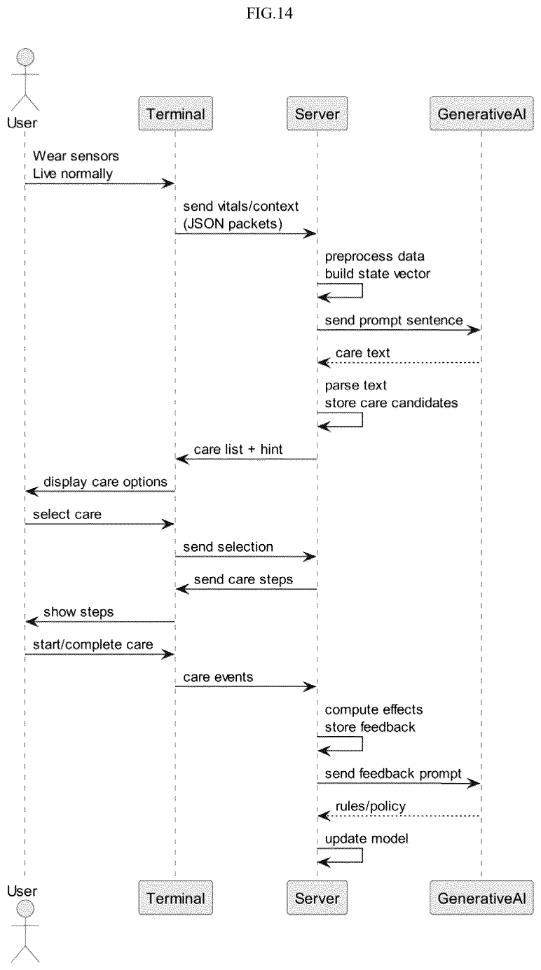

The following describes the processing flow using FIG. 14.

### Step 1:

The terminal acquires biological information and behavior-history information from the user. Input: raw sensor signals from a wearable device (heart rate, blood pressure, body temperature, blood oxygen saturation, accelerometer data) and from a bed sensor (body-movement events, sleep-stage indicators).

The terminal uses a device SDK and a wireless interface to read the raw sensor packets at fixed intervals. The terminal converts each packet into an internal record, attaches a user ID and a timestamp obtained from the system clock, and normalizes units (for example, beats per minute for heart rate). The terminal aggregates measurements from different sensors into a single time-stamped record and serializes the record into a structured format, such as JSON, using a serialization library.

Output: a sequence of structured biological and behavior-history records ready to be sent to the server.

### Step 2:

The terminal acquires image information, audio information, and position information of the user.

Input: video frames from the terminal's camera, audio streams from the terminal's microphone, and beacon signals received via a short-range wireless interface.

The terminal periodically captures a video frame and applies a face-detection algorithm to locate the user's face region. The terminal crops the face region, resizes it to a fixed resolution (for example, 224×224 pixels), and encodes it as a compressed image file. The terminal records a short audio segment, converts it to a standard sampling rate, and stores it in a compressed format. The terminal measures the signal strength of multiple beacons, chooses the beacon with the highest signal strength, and maps the beacon identifier to a room label using an internal lookup table. The terminal bundles the face image, the audio clip, the room label, the user ID, and the timestamp into a single packet.

Output: a multimodal packet containing a face image file, an audio clip file, a position label, and associated metadata.

### Step 3:

The server receives and validates the biological and behavior-history records. Input: the sequence of biological and behavior-history records transmitted by the terminal. The server listens on an application programming interface endpoint and parses incoming structured records. The server checks field presence, verifies that the user ID exists in a user table, and validates that numerical values fall within a physiologically plausible range. The server discards malformed or out-of-range records and logs error information. The server writes valid records into a raw sensor table indexed by user ID and timestamp in the database. Output: a set of validated and stored raw sensor records in the server's database.

### Step 4:

The server preprocesses the biological information and extracts health-state features.

Input: validated raw sensor records from the raw sensor table.

The server loads raw time-series data into a data frame, sorts the data by timestamp, and applies numerical filters. The server performs moving-average smoothing on heart rate and blood pressure, and removes outliers exceeding statistical thresholds. The server groups data into fixed time windows (for example, every 5 minutes) and computes statistical measures such as mean heart rate, heart rate variance, maximum systolic blood pressure, minimum diastolic blood pressure, and sleep fragmentation index from bed-movement counts. The server concatenates these measures into a fixed-length health-state feature vector and stores it in a health-state feature table associated with each time window and user ID.

Output: a sequence of health-state feature vectors representing the user's physical condition over time.

### Step 5:

The server receives and preprocesses the image, audio, and position information. Input: multimodal packets containing face images, audio clips, position labels, user IDs, and timestamps from the terminal.

The server stores the raw media files in a media repository and the metadata in a media context table. The server analyzes the audio clip to compute sound-pressure level and frequency characteristics using an audio processing library. The server classifies the environment into categories such as quiet, normal, or noisy by comparing computed features with predefined thresholds or by using a lightweight classification model. The server encodes the position label and the environment category, and combines them with an activity indicator (for example, step count from another table) to form a context feature vector. The server stores the context feature vector in a context feature table with the corresponding timestamp and user ID.

Output: a sequence of context feature vectors representing the user's situational context.

### Step 6:

The server performs facial-expression analysis to obtain facial emotion scores.

Input: face image files and corresponding timestamps and user IDs from the media repository and media context table.

The server reads each face image, resizes and normalizes it, and converts it into a tensor. The server forwards the tensor through a convolutional neural network trained for facial emotion classification. The network outputs probabilities for categories such as joy, anger, sadness, fear, surprise, and neutral. The server computes facial emotion scores by aggregating these probabilities, for example by defining an anxiety-related score as the sum of the fear probability and a weighted portion of the sadness probability, and a calmness-related score as a sum of neutral and partial joy probabilities. The server stores the facial emotion scores in an emotion-state table keyed by user ID and timestamp.

Output: facial emotion scores associated with each processed face image.

### Step 7:

The server performs speech-based emotion analysis to obtain voice emotion scores. Input: audio clips, acoustic features derived from the clips, timestamps, and user IDs.

The server extracts Mel-frequency cepstral coefficients or spectrograms from each audio clip and arranges them into a sequence of feature vectors. The server forwards this sequence through a sequence model such as a bidirectional recurrent neural network or a transformer encoder trained for speech emotion classification. The model outputs probabilities for categories such as calm, anxious, and possible pain complaint. The server computes voice emotion scores by mapping category probabilities to continuous indicators, such as a voice-based anxiety score and a voice-based pain score. The server stores the voice emotion scores in the emotion-state table linked to the corresponding timestamps and user IDs. Output: voice emotion scores associated with each processed audio clip.

### Step 8:

The server fuses multimodal emotion information and vital features into an emotion vector. Input: facial emotion scores, voice emotion scores, and time-aligned health-state feature vectors for the same user.

The server aligns timestamps to select facial and voice scores and health-state features that fall within a defined time window. The server concatenates these values into a multimodal feature vector. The server forwards this multimodal vector through a multimodal emotion estimation model that includes modality-specific encoders and an attention-based fusion layer. The model computes attention weights for each modality and outputs an emotion vector, including continuous values for anxiety degree, pain degree, depression degree, and calmness degree. The server stores the emotion vector in the emotion-state table.

Output: a time-stamped emotion vector for the user.

### Step 9:

The server constructs an integrated state vector representing the user's current state. Input: the latest health-state feature vector, context feature vector, and emotion vector for a given user.

The server retrieves the most recent feature vectors from the health-state feature table, context feature table, and emotion-state table using the user ID and the current time. The server concatenates these vectors into a single state vector. The server optionally normalizes or scales components so that the state vector maintains numerical stability. The server stores the state vector in a user-state table and caches it in memory for quick access.

Output: a unified state vector representing the user's health state, context, and emotional state at a specific time.

### Step 10:

The server generates an explanatory text from the state vector.

Input: the unified state vector for the user.

The server compares each numerical component of the state vector with reference values such as long-term baselines or clinically defined thresholds. For each component, the server applies rule-based mappings to translate quantitative differences into qualitative phrases, such as “within normal range,” “slightly elevated,” or “significantly decreased.” The server uses templates and phrase concatenation rules to combine these qualitative descriptions into coherent sentences describing health status, environmental context, and emotional state. The server assembles the sentences into a comprehensive explanatory text that is human-readable. Output: a natural-language explanatory text describing the user's current state.

### Step 11:

The server constructs a prompt sentence for the generative AI model.

Input: the explanatory text generated from the state vector and configuration information specifying the desired number of care candidates, output format, and output language. The server generates an instruction sentence that states, for example, how many care candidates to propose, in what language to output, and in what format to describe each candidate. The server concatenates the explanatory text and the instruction sentence with appropriate separators and formatting to form a single prompt sentence. The server logs the prompt sentence for auditing and then sends it to a generative AI model via an application programming interface.

Output: a prompt sentence transmitted to the generative AI model.

### Step 12:

The server receives and parses the response from the generative AI model to obtain structured care candidates.

Input: a natural-language response from the generative AI model corresponding to the prompt sentence.

The server reads the response, which typically contains multiple care candidates described in natural language, often numbered or otherwise separated. The server uses predetermined parsing rules and pattern matching to identify each candidate and extract fields such as a care name, a care purpose, a care priority, and a care procedure. The server constructs a structured data record for each candidate, assigning a unique identifier and storing the records in the care-candidate table.

Output: a set of structured care-candidate records linked to the user state.

### Step 13:

The server generates display data and sends the care candidates to the terminal.

Input: structured care-candidate records and the emotion vector for the user.

The server formats each care candidate into a display object containing fields such as name, brief description, goal, estimated time, and priority. The server examines the emotion vector to determine whether an attention message is needed, for example when the anxiety degree exceeds a threshold. If needed, the server generates an attention message that instructs the caregiver on how to interact with the user (for example, “speak slowly and avoid sudden touch”). The server packages the care candidates and the attention message into a structured payload and transmits the payload to the terminal.

Output: display data sent to the terminal for presentation to the caregiver.

### Step 14:

The terminal presents the care candidates and attention message to the caregiver and collects a selection result.

Input: display data containing multiple care candidates and an optional attention message from the server.

The terminal renders a graphical interface, displaying each care candidate on the screen with its name, summary, goal, and priority, and showing the attention message prominently if present. The terminal monitors touch events or other input actions. When the caregiver selects one of the care candidates, the terminal records the selected candidate's identifier, the user ID, the time of selection, and the caregiver ID from the login session. The terminal transmits this selection result back to the server.

Output: a selection result indicating the chosen care candidate.

### Step 15:

The server records the selected care and provides detailed procedural guidance. Input: the selection result from the terminal, including the selected care candidate identifier, user ID, and selection time.

The server writes a new record to the care-selection table specifying which care candidate was selected, at what time, and for which user. The server retrieves any detailed procedural information associated with the selected candidate from the care-candidate table, such as a step-by-step description or special precautions. The server formats this detailed guidance and sends it to the terminal as supplementary information to support the caregiver during execution.

Output: a care-selection record and guidance data returned to the terminal.

### Step 16:

The terminal records care start and completion events during caregiver operation.

Input: the detailed guidance and care-selection information displayed on the terminal. The terminal presents “start care” and “complete care” controls together with the guidance. When the caregiver initiates the care action, the caregiver activates the “start care” control; the terminal captures the current time as the start time and sends a start event to the server. When the caregiver finishes the care action, the caregiver activates the “complete care” control; the terminal captures the completion time and sends a completion event. Each event includes the care candidate identifier, user ID, caregiver ID, and timestamp.

Output: care start and completion events transmitted to the server.

### Step 17:

The server computes a care-effect indicator from pre- and post-care data.

Input: care start and completion events, raw sensor records, health-state feature vectors, and emotion vectors for the corresponding time periods.

The server defines a pre-care time window before the care start time and a post-care time window after the care completion time. The server queries the database for all relevant health-state features and emotion vectors within these windows. The server computes average values for selected components, such as average anxiety degree, average pain degree, and average heart rate, in each window. The server then calculates differences between post-care and pre-care averages to obtain a care-effect indicator for each component. The server bundles these indicators into an evaluation vector and stores it in the care-effect table, associating it with the specific care execution.

Output: an evaluation vector representing the objective effect of the executed care.

### Step 18:

The terminal collects subjective evaluation information from the caregiver.

Input: a prompt on the terminal to evaluate the effectiveness of the completed care. After the care is completed, the terminal displays an evaluation interface with selectable rating options such as “very effective,” “somewhat effective,” “no change,” and “worsened,” along with a text field for comments. The caregiver selects a rating and may input a free-form comment describing the user's reaction. The terminal packages the rating, comment, user ID, caregiver ID, and care candidate identifier into a subjective evaluation record and sends it to the server.

Output: a subjective evaluation record transmitted to the server.

### Step 19:

The server integrates objective and subjective feedback and updates the prediction model with support from the generative AI model.

Input: evaluation vectors from the care-effect table, subjective evaluation records from the terminal, and historical care-execution logs.

The server links each evaluation vector with the corresponding subjective evaluation and the preceding state vectors to form a care-execution log. The server aggregates multiple logs and summarizes patterns, such as which care types reduce anxiety most under certain contexts. The server generates a natural-language summary from these aggregated patterns and embeds the summary into a prompt sentence that requests rules or model-update policies from the generative AI model. The server transmits this prompt sentence to the generative AI model and receives a response describing recommended weighting adjustments or threshold changes. The server converts the textual recommendations into numeric updates, such as changing feature weights or decision thresholds, and then retrains or fine-tunes the prediction model to reflect these adjustments.

Output: updated model parameters and prediction rules that improve future care-candidate estimation.

### Step 20:

The user receives care that is dynamically optimized based on multimodal data and continuous learning.

Input: the user's ongoing biological information, behavior-history information, image information, audio information, and environment information generated during daily life. The user continues to wear sensors and stay within the instrumented environment. The server and terminal repeatedly execute the preceding steps, updating state vectors, generating prompt sentences, invoking the generative AI model, and refining the prediction model based on new feedback. As a result, the care candidates proposed to caregivers increasingly reflect the user's individual patterns, context, and emotional state. The user receives care actions, such as environmental adjustments and communication strategies, that are more closely tailored to their current needs than those produced by static or rule-based systems.

Output: an evolving sequence of care actions delivered to the user, with improved alignment to the user's health state, context, and emotional state over time.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

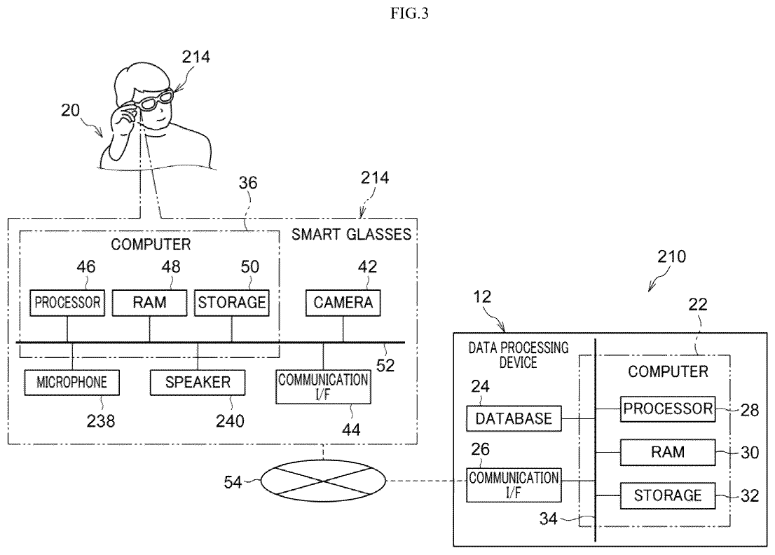

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

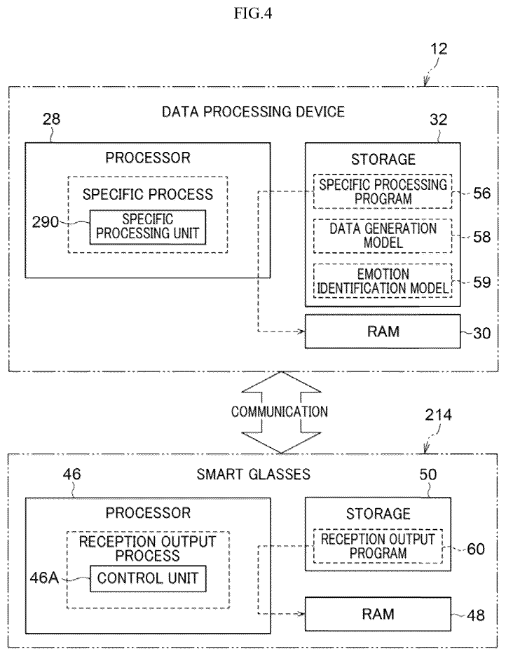

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

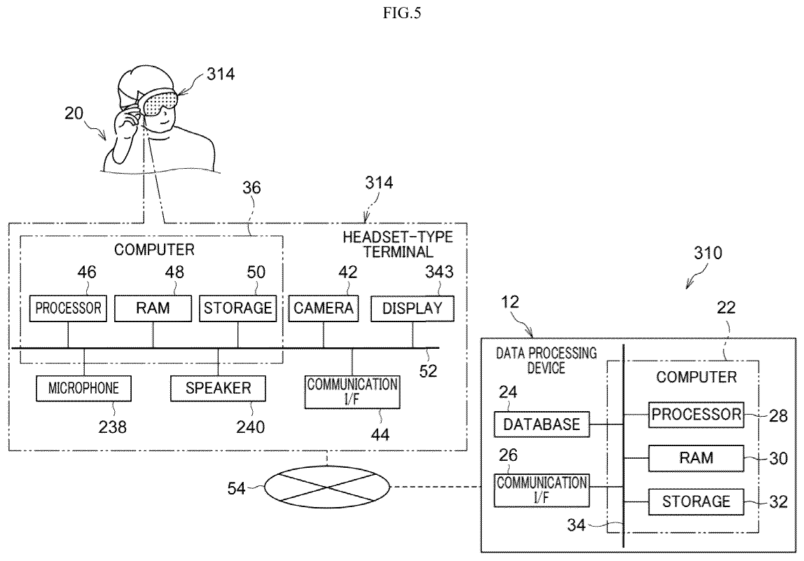

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

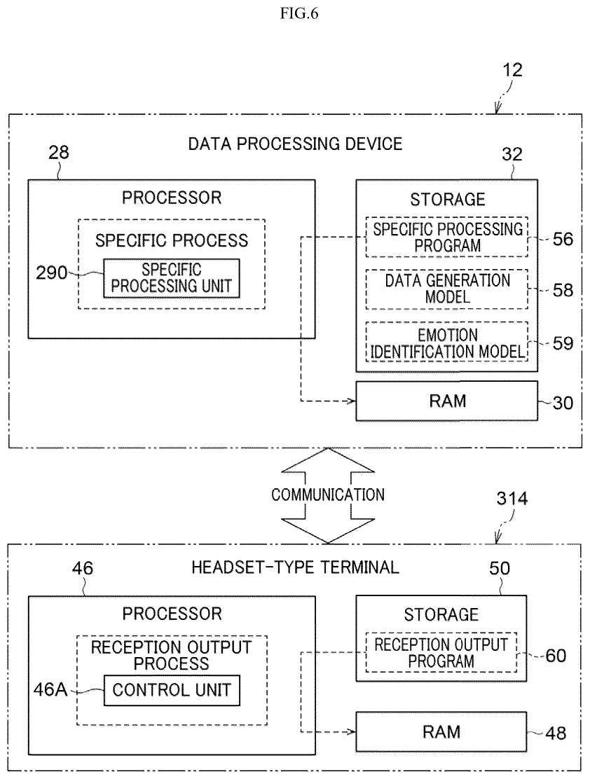

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

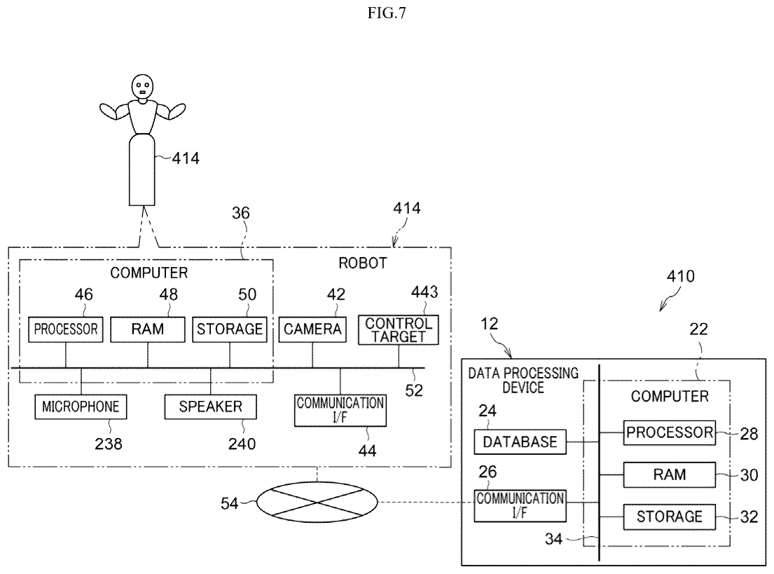

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

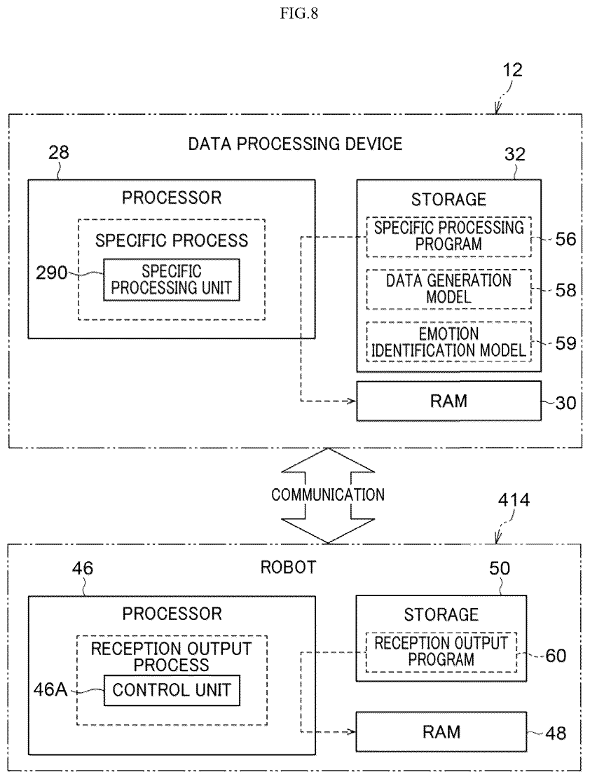

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

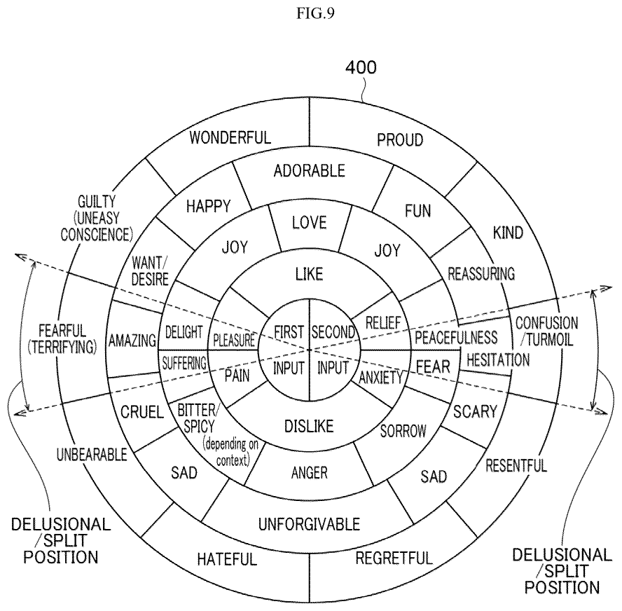

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

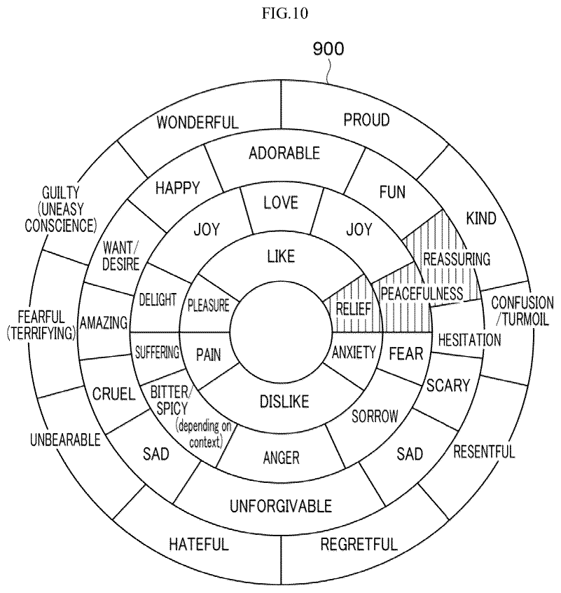

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,

wherein the processor is configured to store and preprocess user knowledge information, language pattern information, and conversation history information,

train or adapt a user-specific language generation model based on the conversation history information,

acquire situation information including location information, time information, and environmental sound information from a terminal device, and structure the situation information as context information,

generate a generation instruction sentence based on the context information and the conversation history information, and input the generation instruction sentence into a generative AI model to cause the generative AI model to generate a plurality of conversation candidate information items,

rank the plurality of conversation candidate information items and select presentation candidate information items based on safety rules and user preference information, transmit the presentation candidate information items to the terminal device and cause the terminal device to present the presentation candidate information items as card-type or similar visual elements via a visual display unit,

acquire a selection result made by a user from among the presentation candidate information items by using a gaze detection mechanism, a contact detection mechanism, or a voice recognition mechanism,

output conversation candidate information corresponding to the selection result to a communication partner via a voice output mechanism or a display output mechanism, store the selection result in association with context information at a time of selection as evaluation information, and update the language generation model or a candidate ranking process based on the evaluation information so as to improve generation accuracy of conversation candidate information in subsequent processing,

automatically increase an output priority of conversation candidate information that is frequently selected under similar context information based on the evaluation information, and encrypt and store the conversation history information, the context information, and the evaluation information of the user, and perform communication with the terminal device using an encrypted communication scheme.

### (Supplementary 2)

The system according to supplementary 1,

wherein the processor is configured to

implement the language generation model as a neural network that models a user speech pattern by time-series learning, fine-tune a pretrained natural language processing model based on the conversation history information of the user, and operate the pretrained natural language processing model as the generative AI model that probabilistically generates content that the user is likely to speak next in response to the generation instruction sentence.

### (Supplementary 3)

The system according to supplementary 1,

wherein the processor is configured to

construct the generation instruction sentence as a prompt sentence including meta-information comprising the conversation history information of the user, the context information, and the user preference information, and an instruction phrase requesting generation of multiple conversation candidate information items optimized for a current context, and input the prompt sentence into the generative AI model to cause the generative AI model to generate the plurality of conversation candidate information items.

### Application Example 1

### (Supplementary 1)

A system comprising a processor,

wherein the processor is configured to

acquire biological information, behavior information, care history information, and conversation history information of a subject, store the acquired information in time series, and generate, based on the stored information, state feature information and care effect feature information for the subject,

acquire position information, environmental sound information, activity amount information, and terminal operation information related to the subject, and generate current situation information and context information,

construct a prompt sentence that forms an input text for generating one or more candidates of care actions or conversation contents to be next provided to the subject, based on the state feature information and the context information, input the prompt sentence and the state feature information and the context information into an internal or external generative AI model, and cause the generative AI model to generate a plurality of care candidates or conversation candidates,

analyze, as structured data, the plurality of care candidates or conversation candidates output from the generative AI model, assign, to each candidate, one or more evaluation indices relating to at least one of urgency, ease of execution, safety, and expected effect, and rank the plurality of candidates based on the evaluation indices,

transmit the plurality of care candidates or conversation candidates to an information processing terminal having a display device or an audio output device, and cause the information processing terminal to present the plurality of care candidates or conversation candidates visually or audibly in a card format or a list format,

obtain a selection result by causing at least one of the subject and a supporter to select at least one of the plurality of presented care candidates or conversation candidates through an input device or a voice input device,

and associate the selection result with at least one of subsequently acquired biological information, behavior information, care result information, and conversation result information, store the associated information as learning data, and update at least one of a model used by the processor and contents of the prompt sentence so as to continuously improve accuracy of generation of the care candidates or conversation candidates in subsequent processing.

### (Supplementary 2)

The system according to supplementary 1,

wherein the processor is configured to input, into the generative AI model configured by a natural language processing technique, a prompt sentence including at least the care history information, the conversation history information, and the context information relating to the subject, and to obtain, from the generative AI model, structured output for each candidate including at least a title, a description, an urgency level, and a rationale.

### (Supplementary 3)

The system according to supplementary 1,

wherein the processor is configured to receive a selection operation performed by at least one of the subject and the supporter by using at least one of a contact-detection input device of the information processing terminal, an eye-gaze detection device, and a voice recognition device, to cause execution support information corresponding to a selected care candidate to be presented on the information processing terminal, and to cause a selected conversation candidate to be used directly as at least one of transmission content to a dialogue partner and audio output content.

### Example 2

### (Supplementary 1)

A system comprising a processor,

wherein the processor is configured to

learn, based on conversation history information of a user and preference information of the user, linguistic tendencies and expression tendencies of the user, and to construct and update a user model as a result of the learning,

acquire context information indicating a situation in which the user is placed, based on position information, time information, and environmental sound information acquired from an information processing apparatus operated by the user, estimate an emotional state of the user representing multiple emotion categories and intensities, based on a plurality of types of feature quantities extracted from an imaging apparatus, a sound acquisition apparatus, and operation log information, and record the emotional state as emotion history information,

generate a prompt sentence including the user model, the context information, and the emotional state, the prompt sentence including an instruction sentence and auxiliary information, and input the prompt sentence to a generative AI model that is a natural language text generation model, thereby causing the generative AI model to generate a plurality of conversation candidates that the user is likely to want to utter next,

calculate, for each of the plurality of conversation candidates, a score based on at least one of past selection history of the user, the context information, and the emotional state, determine a presentation mode including at least a number of candidates to present, a display format, and a degree of emphasis, according to the score and the emotional state, and transmit the plurality of conversation candidates together with the presentation mode to the information processing apparatus for presentation to the user,

acquire, from the information processing apparatus, a selected conversation candidate selected by the user via at least one of gaze input, touch input, and voice input, and acquire associated operation log information including at least an elapsed time from candidate presentation to selection, a number of operations, and a screen scroll amount,

and store, as feedback data, at least the selected conversation candidate, the operation log information, the context information corresponding to a time of selection, and the emotional state corresponding to the time of selection, and update, based on the feedback data, at least part of the user model, a ranking model for the conversation candidates, and an emotional state estimation model, thereby continuously improving accuracy of future conversation candidate generation and presentation control.

### (Supplementary 2)

The system according to supplementary 1,

wherein the processor is configured to

optimize parameters of the user model and parameters of the ranking model for the conversation candidates by executing, using a deep learning library and a matrix computation device, forward propagation computation and backpropagation computation of a neural network model with conversation history information, the context information, and the feedback data as inputs, so as to integrally reflect vocabulary tendencies, expression styles, and selection tendencies of the user corresponding to the emotional state.

### (Supplementary 3)

The system according to supplementary 1,

wherein the processor is configured to

input a plurality of pieces of the feedback data and corresponding context information and emotional states to the generative AI model as a prompt sentence including at least a summarizing description sentence, an instruction sentence, and output conditions, obtain from the generative AI model a description result indicating preference tendencies of the user, including at least one of a tendency that short and simple expressions are likely to be selected under high psychological load, a tendency relating to politeness, a tendency relating to sentence length, and a tendency relating to emotional polarity, analyze the description result to extract features representing the preference tendencies, and incorporate the extracted features into at least one of the user model and the ranking model for the conversation candidates, thereby highly adapting conversation candidate generation and presentation control according to the emotional state and the context information.

### Application Example 2

### (Supplementary 1)

A system comprising a processor,

wherein the processor is configured to

acquire, from one or more sensor devices, biological information, life-history information, and behavior-history information related to a care target, and to model, based on the biological information, the life-history information, the behavior-history information, and care execution results, a health state and a behavior pattern for each care target as a learned model, to acquire, via a communication network, position information and environment information related to the care target, and to generate context information characterizing a current situation of the care target based on the position information, the environment information, and an activity-amount indicator,

to estimate an emotional state of the care target by executing a facial-expression analysis process and a speech-analysis process based on image information, audio information, and the biological information, and to calculate an emotion vector including, as elements, an anxiety degree, a pain degree, a depression degree, and a calmness degree,

to generate a state vector by integrating a health-state feature vector obtained from the learned model, a context feature vector obtained from the context information, and the emotion vector, and to estimate or generate, based on the state vector, a plurality of care candidates to be performed for the care target,

to perform data processing that converts the state vector into a human-readable explanatory text, to construct a prompt sentence including the explanatory text and an instruction sentence that specifies at least one of a number of care candidates, an output format, and an output language, and to transmit the prompt sentence to a generative artificial-intelligence model, to receive, from the generative artificial-intelligence model, a natural-language text output in response to the prompt sentence, to extract, from the natural-language text, at least a care name, a care purpose, a care priority, and a care procedure, to organize the extracted information as structured data, and to generate, as display data, the plurality of care candidates represented by the structured data,

to cause a terminal apparatus to present, via a display device and/or an audio output device of the terminal apparatus, the plurality of care candidates included in the display data and an attention message corresponding to the emotion vector to a caregiver,

to receive, from the terminal apparatus, a selection result indicating at least one care candidate selected from among the plurality of care candidates in accordance with an operation through an input device of the terminal apparatus, and to record the selection result in association with a care target identifier,

to acquire, based on a start time and a completion time of a selected care indicated by the selection result, the biological information and the emotion vector in respective time windows before and after the selected care, to calculate a care-effect indicator based on differences between pre-care values and post-care values of the biological information and the emotion vector, to record the care-effect indicator as an evaluation vector, and to store, as learning data, the evaluation vector in association with subjective evaluation information input by the caregiver, and to reflect the learning data in estimation or generation of the care candidates by updating parameters of the learned model, and

to convert the learning data or summary information thereof into a natural-language explanatory text, to construct a further prompt sentence including the explanatory text and an instruction sentence requesting extraction of characteristics of care having a high care effect and requesting a proposal of a model-update policy, to transmit the further prompt sentence to the generative artificial-intelligence model, to receive, from the generative artificial-intelligence model, at least one rule or update policy output in response to the further prompt sentence, and to adjust parameters of a prediction model used in estimation or generation of the care candidates based on the at least one rule or update policy.

### (Supplementary 2)

The system according to supplementary 1, wherein the processor is configured to

generate, by the data processing that converts the state vector into the human-readable explanatory text, a state-summary text by mapping numerical elements of the health-state feature vector, the context feature vector, and the emotion vector to qualitative expressions based on comparison with reference values, and to construct the prompt sentence by combining the state-summary text with the instruction sentence that specifies a desired number of care candidates, an output format, and an output language for the generative artificial-intelligence model.

### (Supplementary 3)

The system according to supplementary 1,

wherein the processor is configured to

aggregate, from a plurality of care-execution logs, the health state, the context information, the emotional state, performed-care content, the care-effect indicator, and the subjective evaluation information, to generate a natural-language summary text representing the aggregation, to include the summary text in the further prompt sentence to be input to the generative artificial-intelligence model, to obtain, from the generative artificial-intelligence model, at least one weighting rule or threshold-adjustment policy for care-candidate generation that emphasizes improvement of the emotional state, and to update, based on the at least one weighting rule or threshold-adjustment policy, at least one of a loss function, a reward design, and a decision threshold of the prediction model used in the estimation or generation of the care candidates.

What is claimed is:

1. A system comprising:
circuitry configured to:
receive, via a communication interface coupled to a packet-switched network, sensor data from a terminal device and preprocess the sensor data to generate structured context feature data;
retrieve sequence data and associated statistical pattern data from a storage;
construct an input token sequence by concatenating the structured context feature data, a subset of the sequence data, and a generation instruction specifying output constraints;
input the input token sequence to a transformer-based language model and execute autoregressive decoding with a sampling parameter to generate a plurality of output token sequences;
compute a relevance score for each output token sequence on the basis of token-level probability, a learned preference vector, and the structured context feature data;
apply a filtering rule set to remove output token sequences that match a prohibited pattern;
transmit a ranked subset of the output token sequences to the terminal device via the packet-switched network;
receive, from the terminal device, a selection signal identifying a selected output token sequence;
associate the selection signal with the structured context feature data to generate an evaluation record; and
update parameters of at least one of the transformer-based language model and a ranking model on the basis of the evaluation record.

2. The system according to claim 1, wherein the circuitry is configured to preprocess the sensor data by mapping location coordinates to a location category using a geospatial lookup, determining a time-of-day category by comparing time data to predefined intervals, and computing an environmental noise level category from audio power spectrum data, and to encode the location category, the time-of-day category, and the noise level category as the structured context feature data.

3. The system according to claim 2, wherein the circuitry is configured to preprocess the sequence data by tokenizing text into token identifiers using a vocabulary associated with the transformer-based language model, normalizing character encoding, and computing statistical pattern data comprising token frequency counts, n-gram frequency counts, and sentence length distributions.

4. The system according to claim 1, wherein the generation instruction specifies at least a maximum token count for each output token sequence, a language constraint, and a formatting constraint, and wherein the input token sequence further comprises a user attribute segment encoding user preference information derived from the evaluation record.

5. The system according to claim 4, wherein the sampling parameter comprises at least one of a temperature value, a top-k threshold, and a nucleus sampling threshold, and wherein the circuitry is configured to parse a text output of the transformer-based language model into the plurality of output token sequences and to compute a confidence score for each output token sequence on the basis of token-level log-probabilities.

6. The system according to claim 1, wherein the relevance score is computed by a scoring function that combines the token-level probability with a similarity measure between the output token sequence and the learned preference vector, and a context match score between the output token sequence and the structured context feature data, and wherein the circuitry is configured to rank the plurality of output token sequences in descending order of the relevance score.

7. The system according to claim 6, wherein the filtering rule set comprises pattern-matching filters that detect prohibited terms and an auxiliary classification model that assigns a safety score to each output token sequence, and wherein the circuitry is configured to remove output token sequences having a safety score below a predetermined threshold.

8. The system according to claim 1, wherein the circuitry is configured to fine-tune the transformer-based language model by feeding sequences of token identifiers derived from the sequence data into the transformer-based language model, computing a cross-entropy loss between predicted token distributions and actual next tokens, computing gradients using backpropagation, and updating model parameters using an adaptive optimization algorithm.

9. The system according to claim 8, wherein the circuitry is configured to fine-tune a subset of model parameters comprising adapter modules inserted between layers of the transformer-based language model, while keeping remaining model parameters fixed.

10. The system according to claim 1, wherein the circuitry is configured to update the learned preference vector by incrementing frequency counts for tokens contained in the selected output token sequence conditioned on the structured context feature data, and to recompute preference scores used by the scoring function for subsequent ranking operations.

11. The system according to claim 10, wherein the circuitry is configured to automatically increase an output priority of output token sequences that are frequently selected under similar structured context feature data on the basis of accumulated evaluation records.

12. The system according to claim 1, wherein the selection signal is generated by the terminal device using at least one of a gaze detection mechanism that maps gaze coordinates to a display region and registers a selection when a dwell time exceeds a threshold, a contact detection mechanism that identifies a touch event on a display element, and a voice recognition mechanism that maps a recognized utterance to an output token sequence identifier.

13. The system according to claim 1, wherein the circuitry is further configured to cause the terminal device to output the selected output token sequence to a communication partner by at least one of converting the selected output token sequence into synthesized audio using a text-to-speech engine and transmitting the synthesized audio to a speaker, and displaying the selected output token sequence on a display of the terminal device.

14. The system according to claim 1, wherein the circuitry is configured to encrypt the sequence data, the structured context feature data, and the evaluation record prior to storage, and to perform communication with the terminal device using an encrypted communication protocol.

15. The system according to claim 1, wherein the circuitry is further configured to estimate an emotional state of the user using an emotion identification model applied to at least one of audio data, image data, and behavioral interaction data received from the terminal device, and to select a prompt template for the generation instruction on the basis of the estimated emotional state and the structured context feature data.

16. The system according to claim 15, wherein the emotion identification model outputs intensity values for a plurality of emotion categories, and the circuitry is configured to compare each intensity value against a corresponding threshold to determine a user emotional condition, and to adjust at least one of the generation instruction and the scoring function on the basis of the user emotional condition.

17. The system according to claim 1, wherein the circuitry is configured to generate a layout parameter on the basis of the relevance score and user attribute information, and to transmit the layout parameter to the terminal device for adaptation of a display format of the ranked subset of output token sequences.

18. A system comprising:
circuitry configured to:
receive, via a communication interface coupled to a packet-switched network, sensor data comprising location coordinates, time data, and environmental audio data from a terminal device;
map the location coordinates to a location category, determine a time-of-day category from the time data, and compute a noise level category from audio power spectrum data to generate structured context feature data;
retrieve, from a storage, tokenized sequence data and associated statistical pattern data comprising token frequency counts and n-gram frequency counts;
construct an input token sequence by concatenating the structured context feature data, a subset of the tokenized sequence data, user preference information derived from stored evaluation records, and a generation instruction specifying a maximum token count, a language constraint, and a formatting constraint;
input the input token sequence to a transformer-based language model comprising multiple layers of self-attention and feed-forward sublayers, and execute autoregressive decoding with at least one of a temperature value, a top-k threshold, and a nucleus sampling threshold to generate a plurality of output token sequences;
compute a relevance score for each output token sequence by combining token-level log-probability, a similarity measure against a learned preference vector, and a context match score;
apply a filtering rule set comprising pattern-matching filters and an auxiliary classification model to remove output token sequences having a safety score below a predetermined threshold;
transmit a ranked subset of the output token sequences to the terminal device via the packet-switched network;
receive, from the terminal device, a selection signal generated by at least one of a gaze detection mechanism, a contact detection mechanism, and a voice recognition mechanism;
associate the selection signal with the structured context feature data to generate an evaluation record;
update the learned preference vector and at least one of the transformer-based language model and a ranking model on the basis of the evaluation record; and
cause the terminal device to output the selected output token sequence to a communication partner via at least one of a text-to-speech engine and a display.

19. The system according to claim 18, wherein the circuitry is further configured to estimate an emotional state of a user using an emotion identification model applied to at least one of audio data and image data received from the terminal device, and to adjust at least one of the generation instruction and the scoring function on the basis of the estimated emotional state.

20. A method performed by circuitry of a system, the method comprising:
receiving, via a communication interface coupled to a packet-switched network, sensor data from a terminal device and preprocessing the sensor data to generate structured context feature data;
retrieving sequence data and associated statistical pattern data from a storage;
constructing an input token sequence by concatenating the structured context feature data, a subset of the sequence data, and a generation instruction specifying output constraints;
inputting the input token sequence to a transformer-based language model and executing autoregressive decoding with a sampling parameter to generate a plurality of output token sequences;
computing a relevance score for each output token sequence on the basis of token-level probability, a learned preference vector, and the structured context feature data;
applying a filtering rule set to remove output token sequences that match a prohibited pattern;
transmitting a ranked subset of the output token sequences to the terminal device via the packet-switched network;
receiving, from the terminal device, a selection signal identifying a selected output token sequence;
associating the selection signal with the structured context feature data to generate an evaluation record; and
updating parameters of at least one of the transformer-based language model and a ranking model on the basis of the evaluation record.
